(19) United States
(12) Patent Application Publication
(10) Pub. No.: US 2016/0125759 A1
(43) Pub. Date: May 5, 2016

(54) CONDITIONED RESPONSE TOILET TRAINING SYSTEMS AND METHODS

(71) Applicant: Transcontinental Industries, Inc., Seattle, WA (US)

(72) Inventors: Adam Michael DOUGHERTY, Seattle, WA (US); Julian DAVIES, Seattle, WA (US)

(21) Appl. No.: 14/927,430

(22) Filed: Oct. 29, 2015

Related U.S. Application Data
(60) Provisional application No. 62/072,050, filed on Oct. 29, 2014.

(51) Int. Cl. G09B 19/00; G09B 5/00

(52) U.S. Cl. CPC G09B 19/00; G09B 5/00

(57) ABSTRACT

Provided herein are various conditioned response toilet training systems and methods. The various embodiments described herein include components for detecting elimination events reliably and quickly; notifying caregivers of these elimination events; conditioning children such that a specific cue or set of cues becomes associated with the act of elimination; training one or more caregivers to learn the behavioral antecedents and overall elimination patterns of the child; predicting elimination events so that caregivers may be prospectively notified of a likely elimination; and training children to communicate their elimination needs to caregivers.

### CROSS-REFERENCE TO RELATED APPLICATIONS

This application is related to, and claims the benefit of the U.S. Provisional Application entitled “WEARABLE ELECTRONIC DEVICE FOR ACTIVITY TRAINING,” naming Adam Michael Dougherty and Julian Davies as inventors, filed Oct. 29, 2014 (Attorney Ref: 128712-000102), the entire disclosure of which is hereby incorporated herein for all purposes.

### BACKGROUND

1. Field

The present disclosure relates to systems and methods for toilet training, and more particularly, to a systems and methods for detecting eliminations and for creating an association between an elimination and an external cue.

2. Description of Related Art

Conventionally, the average American child begins toilet training at 18-24 months of age and achieves toilet competency around three years of age. Prior to achieving toilet competency, a child may consume several thousand dollars' worth of disposable diapers. Approximately 22 billion such disposable diapers are consumed annually. However, in many of the world's cultures children are toilet trained from a very early age—often from infancy and achieve toilet competency around one year of age, and often earlier. In the United States, the recommended age and method for toilet training have varied considerably over time. In 1932, the U.S. government recommended that mothers begin toilet training immediately after birth and complete it by six to eight months of age.

In many cultures with relatively early toilet training compared to the United States, children are trained using a simple conditioned response method. Babies and young infants are in constant contact with their primary caregivers. Caregivers watch closely for subtle infant signs preceding elimination and provide infants with frequent opportunities to eliminate, usually placing the child in a certain position and/or physical location for elimination. Whenever children eliminate, caregivers provide a conditioning stimulus, often a noise such as “shuus” or “psss”. Over time, both children and caregivers become conditioned: caregivers learn the child's behavioral antecedents to elimination, and the child is conditioned to eliminate when the conditioning stimulus (sound, position, and/or location) is applied. At the same time, children in these cultures typically learn to externally communicate their elimination needs from a very early age.

Such a conditioned response method requires that children be monitored closely by a caregiver so that elimination events and their behavioral antecedents may be observed. This requires a nearly constant presence from caregivers, commonly the child's mother. In traditional societies, such as the Digo of East Africa, new caregivers spend considerable time learning each child's elimination signals. The conditioned response method described above also requires that children be able to eliminate freely, i.e. not within a diaper, so that eliminations may be observed and the conditioning stimulus applied.

For these practical reasons, the conventional conditioned response method is difficult to employ in a modern, post-industrial society. First, children in the U.S. and other developed societies often have numerous caregivers (multiple parents, nannies, day care providers), and these caregivers not be able to dedicate sufficient continued focus on observing elimination events or their antecedents. Second, it is impractical to allow a child to urinate and defecate (“eliminate”) freely inside a modern home. Third, many western cultures do not accept public child nudity or elimination.

Additionally, although conventional diapers offer many conveniences to children and parents, conventional diapers suffer from considerable drawbacks. The average diapered child consumes 4,000 disposable diapers prior to achieving toilet competency, imposing significant financial and environmental costs (roughly $2,000 per child and 7 billion pounds of diaper trash annually in the United States). Additionally, although infants are born with an instinctive desire not to soil themselves, the conventional American method trains children to eliminate in a diaper, and then expects them to unlearn this behavior at their most defiant age, in a scenario where children and parents are often unaware of the child's pre-elimination cues and elimination patterns.

A diaper is a type of underwear typically made of cloth or synthetic disposable materials primarily worn by infants and by children who are not yet toilet trained. When worn, a diaper should trap waste (i.e. urine and/or feces), preventing the waste from soiling other articles of clothing and the wearer's general surroundings. When a diaper becomes soiled, it should be changed. Failure to change a diaper on a sufficiently regular basis can result in skin problems around the area covered by the diaper.

Cloth diapers may include layers of fabric such as cotton, hemp, bamboo or microfiber and can be washed and reused multiple times. Disposable diapers may include contain absorbent chemicals and are intended to be thrown away after use.

### BRIEF DESCRIPTION OF THE DRAWINGS

FIG. 1 illustrates a first exemplary conditioned response toilet training system in accordance with one embodiment.

FIG. 2 illustrates a second exemplary conditioned response toilet training system in accordance with one embodiment.

FIG. 3 illustrates a third exemplary conditioned response toilet training system in accordance with one embodiment.

FIG. 4 illustrates a fourth exemplary conditioned response toilet training system in accordance with one embodiment.

FIG. 5 illustrates a functional block diagram of an exemplary diaper sensing unit in accordance with one embodiment.

FIG. 6 illustrates a flow diagram of exemplary embedded elimination detection and cueing routine in accordance with one embodiment.

FIG. 7 illustrates a flow diagram of an exemplary embedded elimination detection sub-routine in accordance with one embodiment.

FIG. 8 illustrates an exemplary caregiver monitor device in accordance with one embodiment.

FIG. 9 illustrates a flow diagram of an exemplary elimination detection routine in accordance with one embodiment.

FIG. 10 illustrates a flow diagram of an exemplary caregiver elimination event log sub-routine in accordance with one embodiment.

FIG. 11 illustrates a flow diagram of an exemplary caregiver notification sub-routine in accordance with one embodiment.

FIG. 12 illustrates a flow diagram of an exemplary caregiver elimination event log sub-routine in accordance with one embodiment.

FIG. 13 illustrates a functional block diagram of an exemplary dedicated cueing device in accordance with various embodiments.

FIG. 14 illustrates a flow diagram of an exemplary embedded elimination cueing routine in accordance with one embodiment.

FIG. 15 illustrates a functional block diagram of an exemplary remote server in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file servers, computer servers, and/or memory storage devices. Each of these conventional distributed computing components is accessible by the processor via a communication network, which may include, but is not limited to, the Internet.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein. For example, the embodiments set forth below are primarily described in the context of a diaper sensing unit, a caregiver monitoring device, a dedicated cueing component, and/or a remote server. However, these embodiments are exemplary and are in no way limited to the explicitly described configurations. For example, alternate embodiments may be configured that does not include one or more of those components and may include additional components, such as an enhanced training-toilet and/or an enhanced waste receptacle.

### Exemplary Conditioned Response Toilet Training Systems

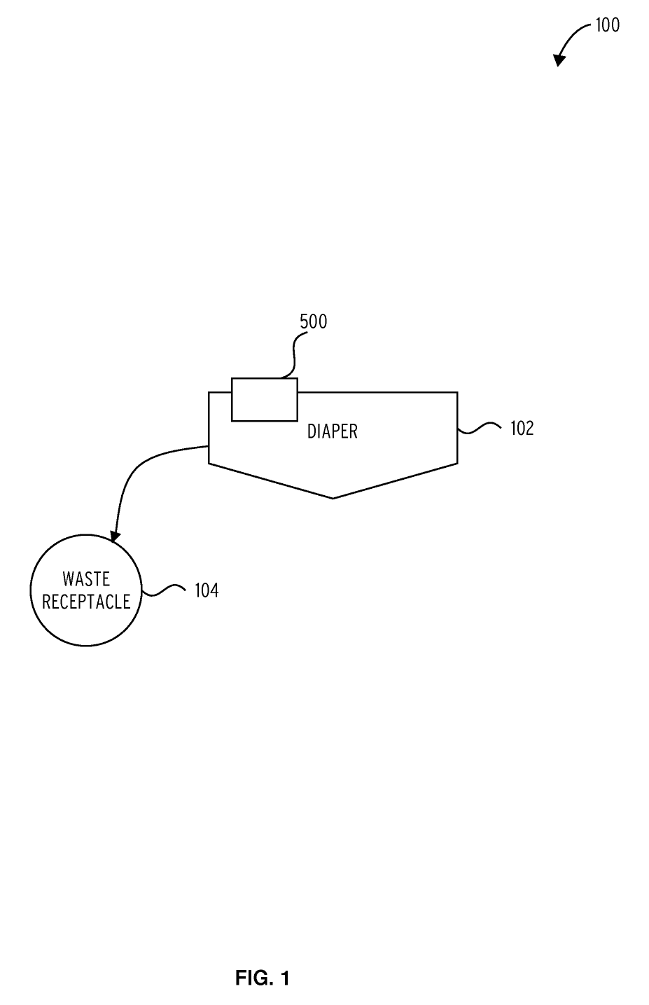

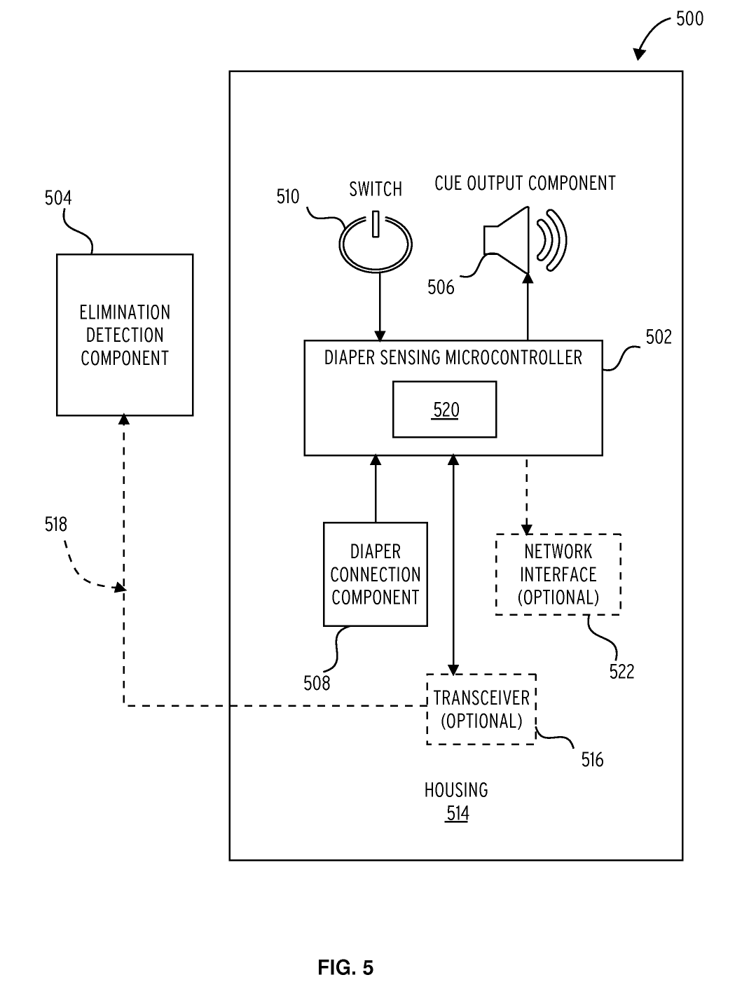

FIG. 1 illustrates a first exemplary embodiment of a conditioned response toilet training system 100. A diaper sensing unit 500, described below in reference to FIG. 5, is installed on a conventional diaper 102. As is described below, upon detecting elimination, diaper sensing unit 500 may provide a cue to both an infant (not shown) wearing the diaper and a caregiver (not shown) in infant's vicinity.

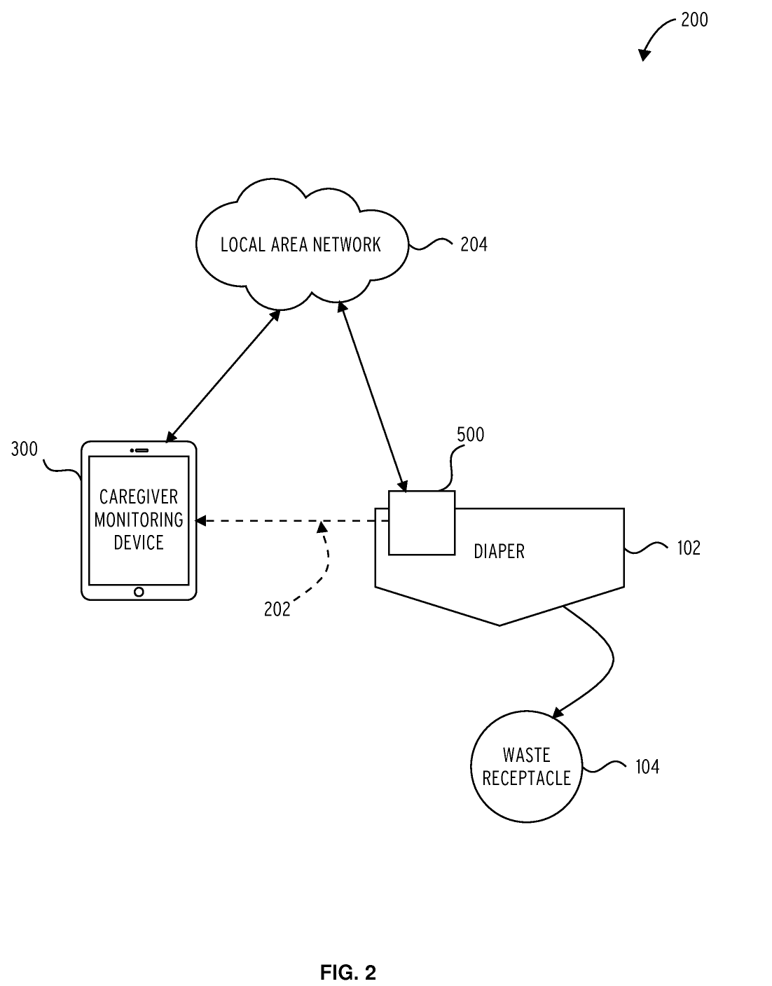

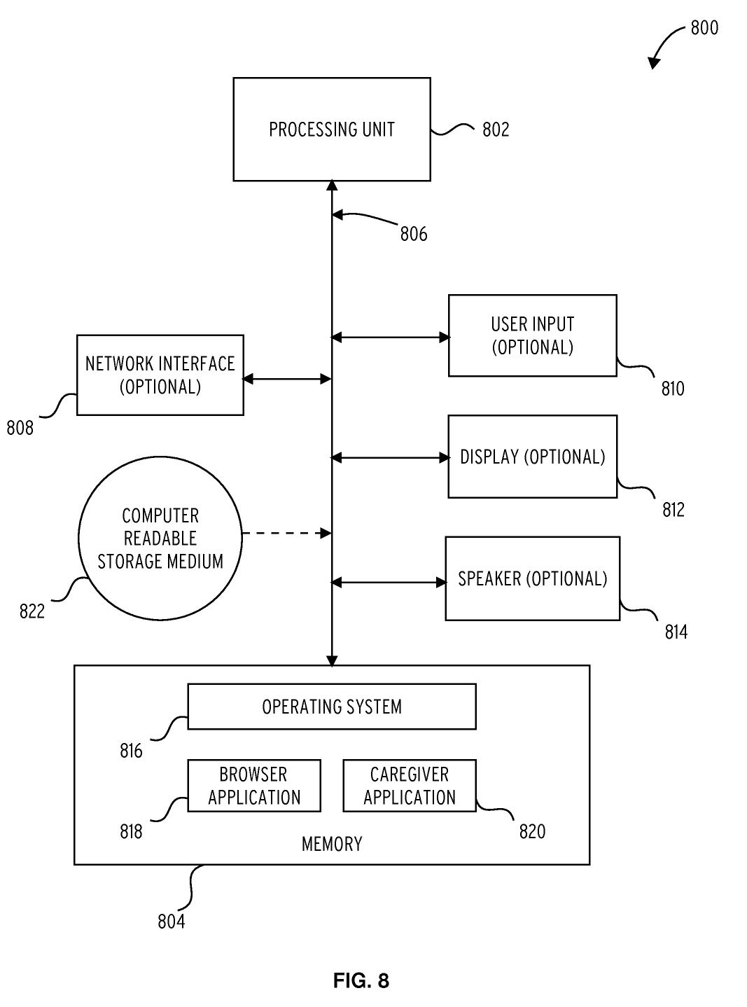

FIG. 2 illustrates a second exemplary conditioned response toilet training system 200. The functionality of the second exemplary conditioned response toilet training system 200 is similar to the functionality of the first exemplary conditioned response toilet training system 100, described above with reference to FIG. 1. However, in the case of second exemplary conditioned response toilet training system 200, diaper sensing unit 500, may be in data communication with a caregiver monitor device 800, described below in reference to FIG. 8. The data communication between diaper sensing unit 500 and caregiver monitor device 800 may be accomplished via a direct, device-to-device wireless connection 202 (e.g. Bluetooth) (indicated by dotted lines in FIG. 2) or via one or more networks, such as local area network 204.

As is described in more detail below with reference to FIG. 8, in some embodiments of conditioned response toilet training system 200, certain functions performed by diaper sensing unit 500 in conditioned response toilet training system 100 may be performed instead by caregiver monitor device 800. For example, the data communication between diaper sensing unit 500 and caregiver monitor device 800 enables a cue to be provided via caregiver monitor device 800 as well as diaper sensing unit 500 and a caregiver (not shown) may deactivate the cue via caregiver monitor device 800 instead of, or in addition to, via diaper sensing unit 500.

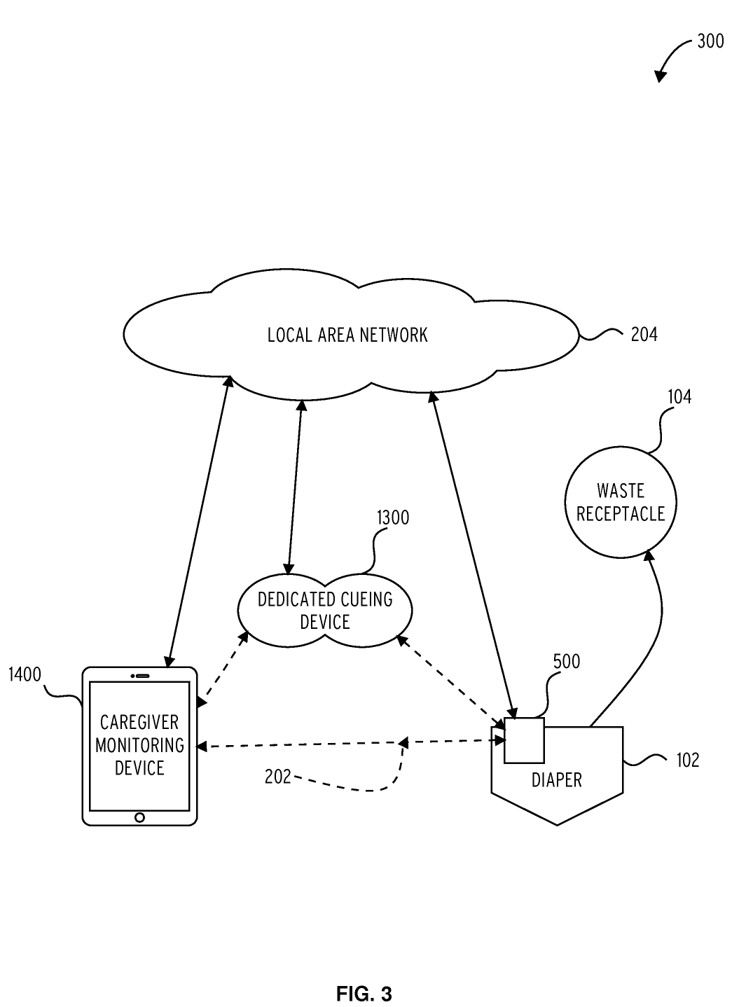

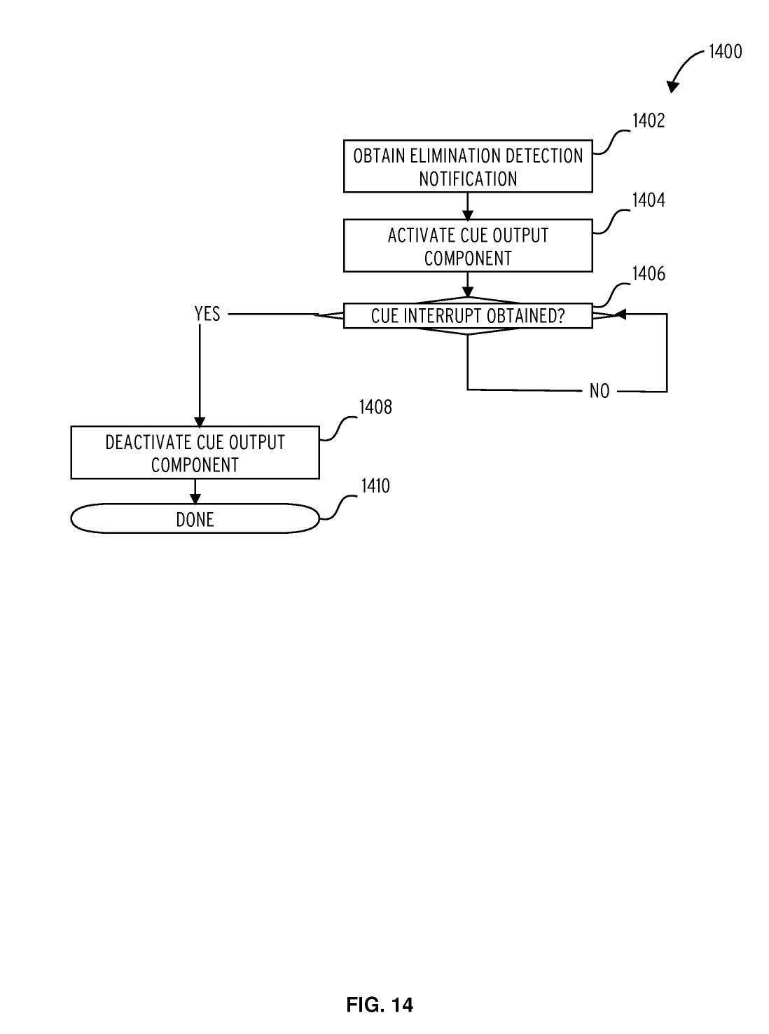

FIG. 3 illustrates a third exemplary conditioned response toilet training system 300. The functionality of conditioned response toilet training system 300 is similar to the functionality of second exemplary conditioned response toilet training system 200, described above with reference to FIG. 2. However, in the case of third exemplary conditioned response toilet training system 300, diaper sensing unit 500 and/or 800 may be in data communication with a dedicated cueing device 1400, described below in reference to FIG. 14. As is explained in more detail below, in some embodiments of conditioned response toilet training system 300, certain functions performed by diaper sensing unit 500 in conditioned response toilet training system 100 and/or conditioned response toilet training system 200 may be performed instead by dedicated cueing device 1400 in conditioned response toilet training system 300. The data communication between dedicated cueing device 1400 and diaper sensing unit 500 and/or caregiver monitor device 800 may be accomplished via direct device-to-device wireless connection 302 and device-to-device wireless connection 304 (e.g. Bluetooth) (indicated by dotted lines) or via one or more networks, such as local area network 204.

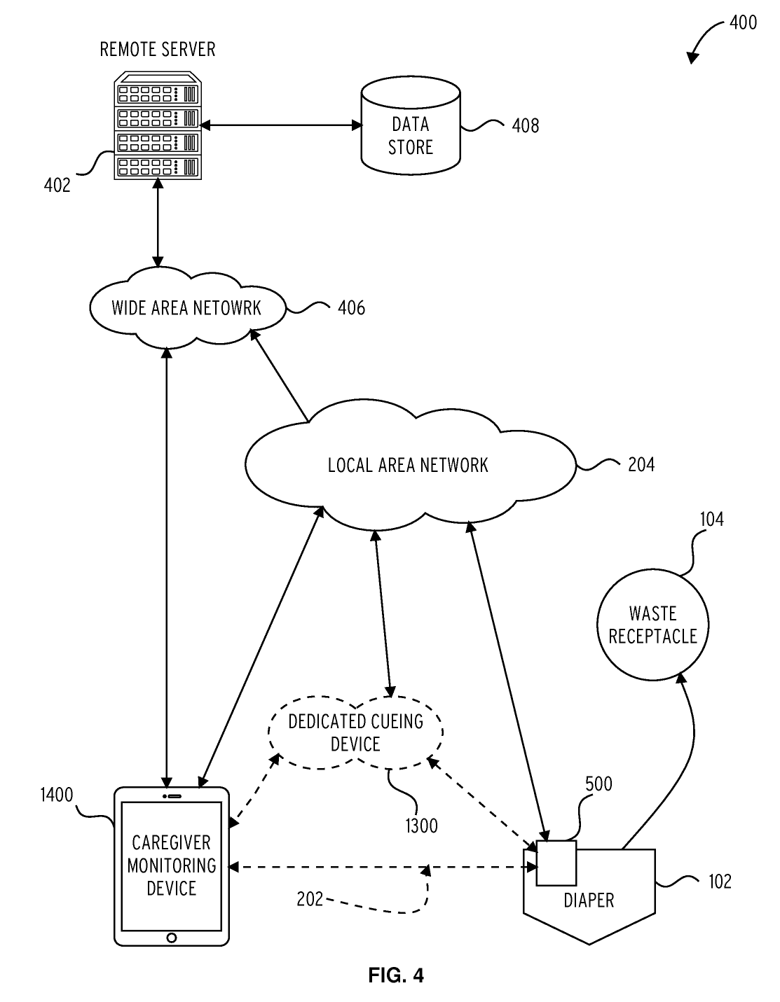

FIG. 4 illustrates a fourth exemplary conditioned response toilet training system 400. The functionality of the fourth exemplary conditioned response toilet training system 400 is similar to the functionality of the second exemplary 200, described above with reference to FIG. 2. However, in the case of fourth exemplary conditioned response toilet training system 400, caregiver monitor device 800 may be in data communication with a remote server 1600, described below in reference to FIG. 16. The data communication between caregiver monitor device 800 and remote server 1600 may be accomplished via one or more networks, such as local area network 204 and wide area network 406. In various embodiments, wide area network 406 may include the Internet, one or more local area networks (“LANs”), one or more wide area networks (“WANs”), cellular data networks, and/or other data networks. Wide area network 406 may, at various points, be a wired and/or wireless network.

Referring generally to FIGS. 1-4, in accordance with various embodiments of the present conditioned response toilet training systems and methods, a caregiver (not shown) may utilize diaper sensing unit 500, for instance by installing diaper sensing unit 500 in a diaper 102. When the infant urinates or defecates (“eliminates”), diaper sensing unit 500 may detect the presence of waste. Diaper sensing unit 500 may responsively emit a cue, e.g. a phonetic sound such as “psss” or another, customizable, and/or user-recorded sound. (Note that although an auditory cue is used in the present examples, other sensory cues may be used alternatively or additionally, including cues based on visual stimulus, haptic stimulus, and/or the like.) The cue provides feedback to the infant. Over time, the cue-based feedback may condition the infant (and the caregiver) to associate the audio cue with the infant's elimination. The caregiver, upon hearing the audio cue, may move the infant to a waste receptacle 104 (e.g. a toilet, such as the enhanced training-toilet described below) where the infant can complete the elimination process. When the infant has finished eliminating (or when the infant reaches the waste receptacle, whichever event occurs later), the caregiver may then deactivate the cue being emitted from diaper sensing unit 500.

Over the course of the infant's growth and development, the infant may become more aware of the physiological sensations preceding and associated with elimination and associate the cue with the act of elimination. Meanwhile, the caregiver may become attuned to the infant's pre-elimination behaviors and overall elimination patterns.

When the infant is sufficiently conditioned, the caregiver may place the infant on a waste receptacle 104 (e.g. a toilet) at times when the caregiver believes the infant is likely to eliminate, such as after waking or feeding. The caregiver may simultaneously prompt the infant to eliminate by either vocalizing the cueing sound or by triggering diaper sensing unit 500 (or dedicated cueing device 1400) to emit the cue.

After a period of consistent use, e.g. two months, the infant may successfully eliminate on the toilet a majority of the time, e.g. with less than one miss per day. At this point, the caregiver may selectively switch from providing the infant with disposable diapers to a washable cloth diaper “outer” with a choice of cloth or disposable inner liners.

After an additional period of consistent use, e.g. four to five months, the infant may learn to proactively communicate the infant's elimination needs, further reducing the miss rate (i.e. the frequency with which the infant eliminates without being brought to the toilet and cued). At this point the caregiver to may selectively switch from providing the infant with the cloth diaper and transition to cloth underwear. Although the infant may not yet be fully toilet trained, e.g. the infant cannot yet independently travel to the toilet, remove its own clothing, or clean itself, the infant may have developed control over, awareness of, and an ability to communicate about the infant's elimination needs such that disposable diapers become unnecessary.

### Exemplary Diaper Sensing Units

FIG. 5 illustrates an exemplary diaper sensing unit 500 in accordance with various embodiments. A diaper sensing microcontroller 502 may be electrically connected to an elimination detection component 504, described below. Diaper sensing microcontroller 502 may also be electrically connected to a cue output component 506 and a switch 510. In some embodiments, described in more detail below, diaper sensing microcontroller 502, cue output component 506, and switch 510 may be disposed in an optional housing 514 while elimination detection component 504 may be incorporated into a flexible RFID tag (not shown), or the like. In such embodiments, diaper sensing unit 500 may also include a 220, also disposed within optional housing 514, for communicating with elimination detection component 504 via a wireless connection 518.

In some embodiments, such as conditioned response toilet training system 200, described below in reference to FIG. 2, diaper sensing unit 500 may also include an optional network interface 522 for wirelessly connecting to other devices and/or networks, such as caregiver monitor device 800 and/or local area network 204.

Diaper sensing microcontroller 502 may include a processing unit (not shown) and memory (not shown) containing executable instructions for causing the processing unit to perform an embedded elimination detection and cueing application 520, the functionality of which is described below.

Elimination detection component 504 may include a sensor or sensors (not shown) that enable diaper sensing unit 500 to detect the presence of urine or fecal matter in the diaper (an “elimination event”). By way of example, elimination detection component 504 may include one or more sensors (not shown) for detecting a change in electrical conductivity/resistance between two or more conductive elements when urine and/or feces are present. Designs include but are not limited to conductive thread, wire, or other material sewn, glued, woven, or otherwise attached to a diaper or a diaper liner; conductive tape, conductive ink or other electrical tracing printed or woven directly onto the diaper or a diaper liner; one or more traces within the diaper or diaper liner consisting of dissolvable conductive material, such that urine or the moisture in feces dissolves part of the trace, interrupting electrical continuity; two or more layers of conductive fabric, mesh, or other conductive material in a sandwich configuration, separated by a non-conductive but moisture permeable material; and flexible sensors that are inserted or otherwise placed into the diaper or diaper liner, for example in a pocket or sleeve within the diaper or diaper liner or equivalent garment.

By way of further example, elimination detection component 504 may include one or more sensors (not shown) for detecting chemicals present in urine or feces, such as a “bio-battery” consisting of paper that is soaked in copper chloride and sandwiched between layers of magnesium and copper or a bio-battery consisting of cellulose and aligned carbon nanotubes. In an elimination detection component 504 equipped with such sensors, the presence of urine or feces would activate the bio-battery and generate an electrical current, signaling the elimination event. In some embodiments, such a bio-battery may be used to provide power to the elimination detection component 504 and/or other components of the diaper sensing unit 500, as indicated by dashed line 112.

By way of further example, elimination detection component 504 may additionally or alternatively included one or more sensors (not shown) for detecting a change in electrical capacitance. Such a capacitive sensor may be placed outside the diaper or within the diaper, for example in between an absorbent liner and an outer diaper cover. For example, a capacitive sensor may include two or more layers of conductive fabric or mesh in a sandwich configuration, separated by a non-conductive but moisture permeable material. Alternatively, a capacitive sensor may include a capacitive divider, with one capacitor woven or otherwise positioned in an absorbent part of the diaper, and the other capacitor outside the absorbent part, either between the liner and the outer diaper cover or outside the diaper itself. The electrically conductive layers of one or both of these capacitors may be encased or otherwise surrounded by plastic or another non-electrically conductive, waterproof material, so that conductive metals or other conductive materials are not exposed directly to moisture, either from child elimination or item laundering.

By way of further example, elimination detection component 504 may additionally or alternatively include one or more sensors for detecting a change in temperature. Such a temperature sensor may be placed outside the diaper or within the diaper, for example in between the absorbent liner and the outer diaper cover.

In some embodiments, multiple sensing locations may be used, such as sensors in the inner portion of the diaper/garment to detect urination onset combined with sensors in the more outer or distal areas of the diaper/garment to sense a full diaper. Ventral sensors may detect urination with dorsal sensors for stool.

In order to limit power consumption of diaper sensing unit 500, diaper connection component 508 may include a sensor or sensors (not shown) that enable embedded elimination detection and cueing application 520 to detect whether diaper sensing unit 500 is connected to a diaper, such as diaper 102. For example, diaper connection component 508 may include a resistive element (not shown) placed between two electrical contacts (not shown) on a diaper. When diaper sensing unit 500 is installed properly in the diaper, the resistive element may contact the two electrical contacts and diaper connection component 508 may detect the changed resistance and responsively provide a signal to diaper sensing microcontroller 502. By way of further example, diaper connection component 508 may include a capacitive element (not shown) placed between two electrical contacts (not shown) on a diaper. When diaper sensing unit 500 is installed properly in the diaper, the capacitive element may contact the two electrical contacts and diaper connection component 508 may detect the changed capacitance and responsively provide a signal to diaper sensing microcontroller 502. By way of further example, diaper connection component 508 may include a mechanical switch (not shown) that is actuated when diaper sensing unit 500 is installed in a diaper and diaper connection component 508 may detect the actuation of the mechanical switch and responsively provide a signal to diaper sensing microcontroller 502.

When elimination detection component 504 is not connected to a diaper, embedded elimination detection and cueing application 520 may wake relatively infrequently, e.g. every 10-15 seconds, to monitor for a new diaper connection. If a diaper is detected, embedded elimination detection and cueing application 520 may wake more frequently, e.g. one to four times per second, to monitor the presence or absence of urine or feces in the diaper.

In accordance with various embodiments of diaper sensing unit 500, elimination detection component 504 may be a physically separate component from the other components of diaper sensing unit 500 and, in such embodiments, the data communication between elimination detection component 504 and diaper sensing microcontroller 502 may be accomplished by wireless connection 518 (as indicated by dotted lines) using dynamic RFID, NFC, or other suitable known wireless data and power transfer protocol (including inductive or other wireless power transfer methods). In such an embodiment, elimination detection component 504 may be incorporated into a flexible RFID-style tag placed inside the diaper (either within the diaper liner, in between the diaper liner and the outer cover) or outside the diaper.

In such embodiments, elimination detection component 504 may contain one or more sensors, as described above, and an energy harvesting device (not shown), such that elimination detection component 504 has no wired electrical connection to other components of diaper sensing unit 500. Rather, elimination detection component 504 may obtain power from and transmit data to an optional transceiver 516 disposed in a remote optional housing 514 via wireless connection 518. In such an embodiment, diaper sensing microcontroller 502, cue output component 506, and switch 510, may also be disposed in optional housing 514, and optional housing 514 may be installed in the diaper cover or otherwise attached to the infant or its clothing.

In such embodiments, diaper sensing unit 500 utilizes wireless connection 518 to provide power to the energy harvesting device which in turn powers the other components of elimination detection component 504, e.g. to perform one or more temperature, resistance/conductivity, or capacitance measurements and return results to 216. Such an embodiment removes the need for a physical connection between the diaper and the optional housing 514. In such an embodiment, a separate diaper connection component 508 may be unnecessary, as embedded elimination detection and cueing application 520 may consider itself “connected” to a diaper whenever embedded elimination detection and cueing application 520 can detect a connected (or “paired”) elimination detection component 504 via wireless connection 518.

In embodiments where diaper sensing microcontroller 502 requires a direct electrical connection to elimination detection component 504, both a mechanical connection between diaper sensing unit 500 and diaper 102 and an electrical connection between diaper sensing microcontroller 502 and elimination detection component 504 should be made when installing diaper sensing unit 500 in diaper 102. In certain embodiment, the following mechanical attachment components may have inherent conductive properties and/or position diaper sensing microcontroller 502 to contact conductive elements of the diaper 102 and/or elimination detection component 504. Such mechanical attachment components include:
One or more metal or synthetic snaps.
One or more hook and loop fastenings.
Magnetic fasteners, either between diaper sensing unit 500 and the diaper, or magnetic fasteners within optional housing 514, such that optional housing 514 clamps over the diaper and attaches to itself.
Optional housing 514 having a clamshell or clamping device that clips to the diaper.
Attachments involving post/s and clamp/s, bayonet/s and clutch/es, or grabbing hook/s/teeth, which may pierce the diaper or be inserted through pre-existing hole/s or loop/s in diaper to secure a mechanical and electrical connection.
A pouch, sleeve, or pocket in the diaper that holds diaper sensing unit 500 through friction, magnetism, adhesive, hook-and-loop fasteners, a clip, or a closable opening.
An attachment method in which an adhesive portion of the diaper holds diaper sensing unit 500 in place; the adhesive may be covered by a flap or removable backing prior to use.
A configuration wherein elimination detection component 504 comprises an insertable sensing strip that is disposed inside the diaper and holds optional housing 514 in place, e.g. at the top of or outside the diaper when the diaper is fastened. The sensing strip may have adhesive to keep it in place inside the diaper.

In an embodiment where optional housing 514 is attached to an outer diaper cover, but elimination detection component 504 is contained in a diaper liner, the fastening methods may have conductive properties that can electrically connect diaper sensing microcontroller 502 to elimination detection component 504.

### Exemplary Embedded Elimination Detection and Cueing Routine

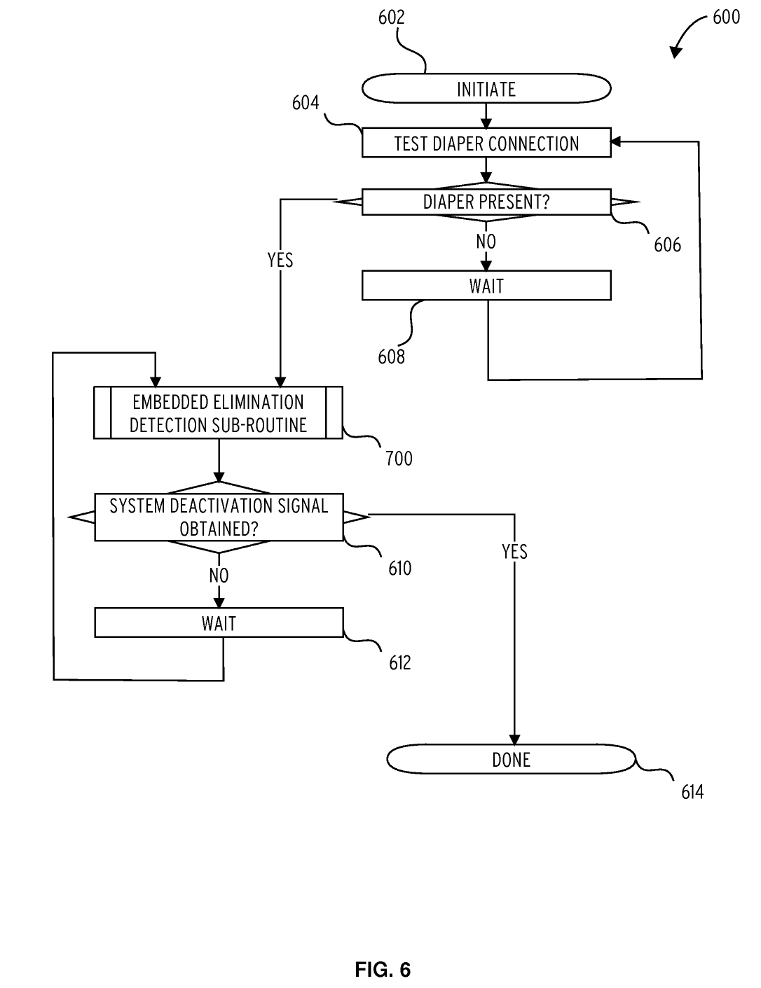

FIG. 6 illustrates a flow diagram of an exemplary embedded elimination detection and cueing routine 600 which may be performed by embedded elimination detection and cueing application 520 operating on diaper sensing microcontroller 502 of exemplary diaper sensing unit 500.

Embedded elimination detection and cueing routine 600 may initiate at starting block 602, for example in response to switch 510 being engaged by a user of exemplary diaper sensing unit 500. Upon initiation, embedded elimination detection and cueing routine 600 may optionally reset the input from elimination detection component 504, for example to establish a baseline corresponding to a “dry” or “clean” diaper state (not shown).

Embedded elimination detection and cueing routine 600 may test diaper connection component 508 to determine whether diaper sensing unit 500 is connected to a diaper at execution block 604.

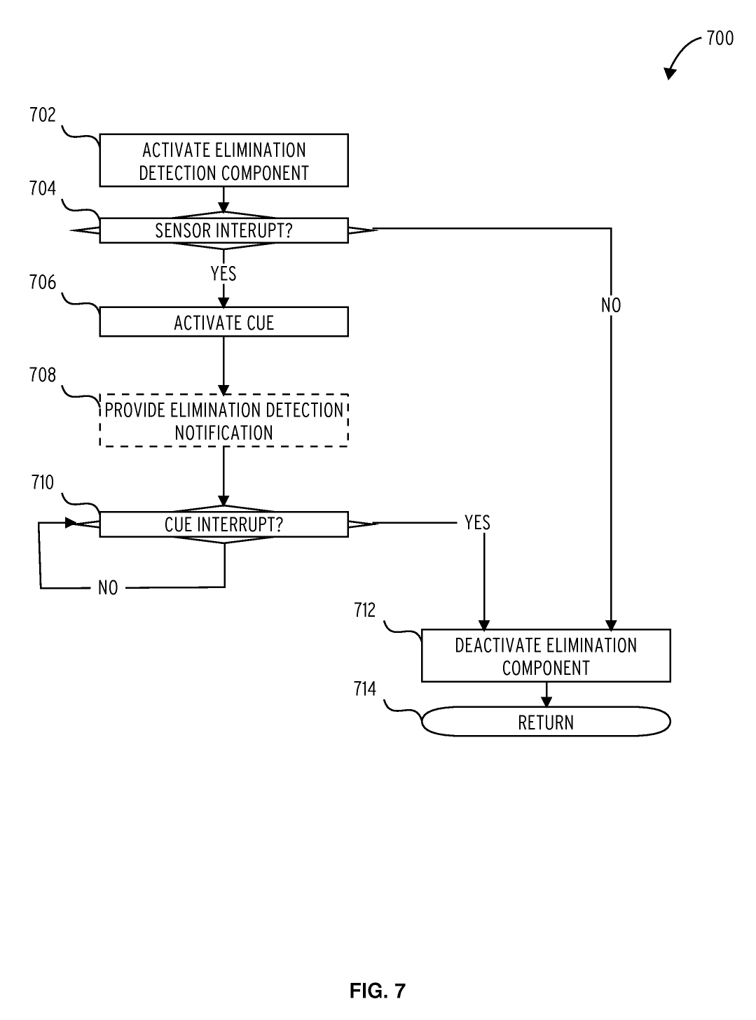

At decision block 606, if embedded elimination detection and cueing routine 600 determines diaper sensing unit 500 is not connected to a diaper, 300 may proceed to execution block 608; otherwise, embedded elimination detection and cueing routine 600 may proceed to call embedded elimination detection sub-routine 700, described below in reference to FIG. 7.

At execution block 608, embedded elimination detection and cueing routine 600 may wait a predefined period, e.g. ten seconds, fifteen seconds, etc., and then loop back to execution block 604.

At decision block 610, if embedded elimination detection and cueing routine 600 obtains a system deactivation signal, for example in response to switch 510 being engaged by a user of exemplary diaper sensing unit 500, embedded elimination detection and cueing routine 600 may proceed to termination block 614; otherwise embedded elimination detection and cueing routine 600 may proceed to block 612.

At execution block 612, embedded elimination detection and cueing routine 600 may wait a predefined period, e.g. one tenth of a second, half of second, etc., and then loop back to embedded elimination detection sub-routine 700.

At termination block 614, embedded elimination detection and cueing routine 600 ends.

### Embedded Elimination Detection Sub-Routine

FIG. 7 illustrates a flow diagram of an exemplary embedded elimination detection sub-routine 700 which may be performed by diaper sensing microcontroller 502 of exemplary diaper sensing unit 500.

Embedded elimination detection sub-routine 700 may activate elimination detection component 504 at execution block 702.

At decision block 704, if embedded elimination detection sub-routine 700 obtains a sensor interrupt signal form elimination detection component 504, indicating a “wet” or “dirty” diaper state, embedded elimination detection sub-routine 700 may proceed to execution block 706; otherwise, embedded elimination detection and cueing routine 600 may proceed to execution block 712.

At execution block 706, embedded elimination detection sub-routine 700 may activate a cueing response, for example by providing a cueing signal to cue output component 506.

In some embodiments of the present conditioned response toilet training systems, embedded elimination detection sub-routine 700 may provide an elimination detection notification, e.g. to a caregiver application 820 operating on a caregiver monitor device 800, at optional execution block 708.

At decision block 710, embedded elimination detection sub-routine 700 waits for a cue interrupt, for example in response to switch 510 being engaged by a user of exemplary diaper sensing unit 500. If embedded elimination detection sub-routine 700 obtains a cue interrupt, embedded elimination detection sub-routine 700 may proceed to execution block 712.

At execution block 712, embedded elimination detection sub-routine 700 may deactivate elimination detection component 504.

Embedded elimination detection sub-routine 700 returns to embedded elimination detection and cueing routine 600 at return block 714.

### Exemplary Caregiver Monitor Device

FIG. 8 several components of an exemplary caregiver monitor device 800 are illustrated. In some embodiments, a caregiver monitor device 800 may include many more components than those shown in FIG. 8. However, it is not necessary that all of these generally conventional components be shown in order to disclose an illustrative embodiment. As shown in FIG. 8, exemplary caregiver monitor device 800 includes a processing unit 802 in data communication with memory 804 via a bus 806. As used herein, a “processing unit” refers to the electronic circuitry within a computing device that executes the instructions of a computer program, such as an operating system 816, a browser application 818, and/or a caregiver application 820, described below, by performing the basic arithmetic, logical, control and input/output (I/O) operations specified by the instructions. Memory 804 may generally comprise some or all of random access memory (RAM), read-only memory (ROM), and/or a permanent mass storage device, such as a disk drive, flash memory, or the like. Caregiver monitor device 800 may also include a network interface (optional) 808, a user input (optional) 810, a display (optional) 812, and/or a speaker (optional) 814.

Memory 804 of exemplary caregiver monitor device 800 may store an operating system 816, as well as program code for a number of software applications, such as a browser application 818 and a caregiver application 820. Browser application 818 is a software application for retrieving, presenting, and traversing information resources on a network, such as wide area network 406. Although browser application 818 may be primarily intended to use the World Wide Web, it may also be used to access information resources provided by remote servers in private networks. An information resource may be a web page, an image, a video, or other piece of content and may be identified by a Uniform Resource Identifier (URI/URL) on wide area network 406. An information resource may also provide browser application 818 executable program code for web applications, i.e. a software application that runs in and is rendered by browser application 818.

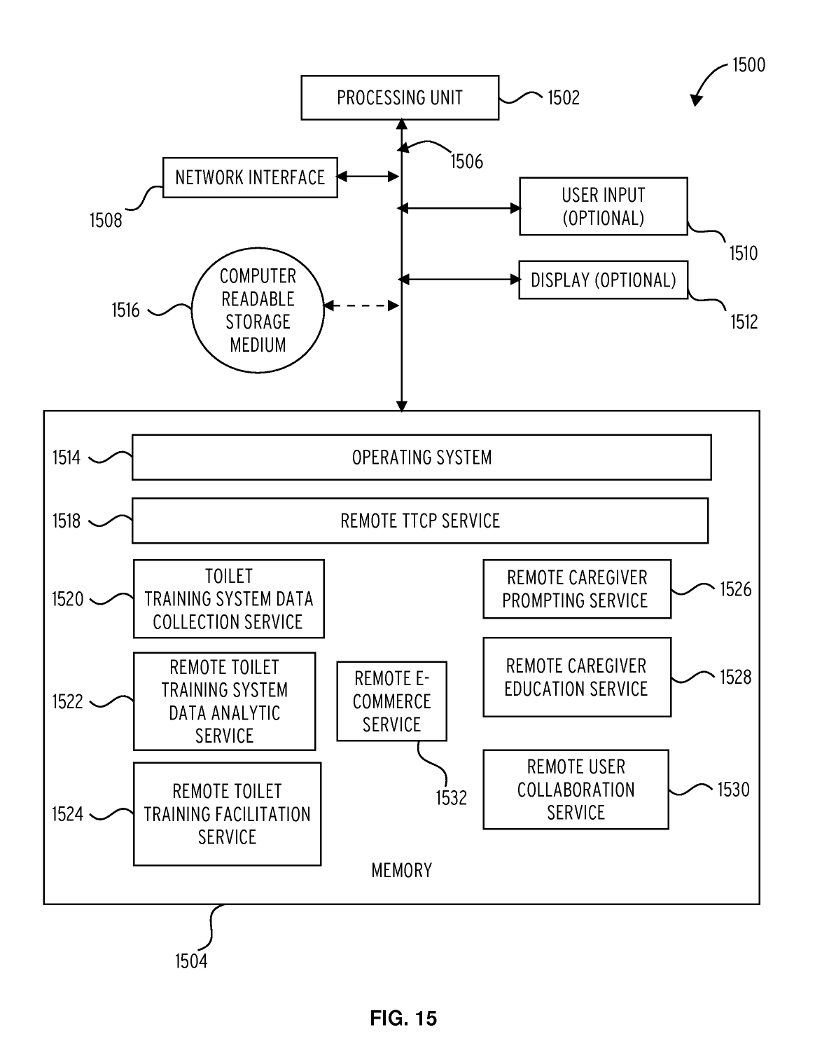

As is described in more detail below, caregiver application 820 may interface with various embodiments of a diaper sensing unit, such as diaper sensing unit 500, as well as various embodiments of a remote toilet training community portal service, such as remote toilet training community portal service 1518, described below in reference to FIG. 15.

These and other software components, as well as various data files (not shown) may be loaded into memory 804 via network interface (optional) 808 (or via a selectively removable computer readable storage medium 822, such as a memory card or the like).

In operation, operating system 816 manages the hardware and software resources of the caregiver monitor device 800 and provides common services for various software applications, such as caregiver application 820. For hardware functions such as network communications via network interface (optional) 808, obtaining data via user input (optional) 810, rendering data via display (optional) 812 and/or speaker (optional) 814, and allocation of memory 804 to various resources, operating system 816 may act as an intermediary between software executing on caregiver monitor device 800 and the client device's hardware. (In the case of a web application, the browser application 818 similarly acts as an intermediary between the web application's program code and the operating system 816.)

For example, operating system 816 may cause a representation of available software applications, such as caregiver application 820, to be rendered via display (optional) 812. If operating system 816 obtains, e.g. via user input (optional) 810, a selection of caregiver application 820, operating system 816 may instantiate a caregiver application process (not shown), i.e. cause processing unit 802 to begin executing the executable instructions of caregiver application 820 and allocate a portion of memory 804 for its use.

Although an exemplary caregiver monitor device 800 has been described, a caregiver monitor device 800 may be any of a great number of computing devices capable executing program code, such as the program code corresponding to operating system 816 and caregiver application 820.

### Indirect Sensing

In addition to direct sensing of urine or feces, described above with respect to elimination detection component 504, various embodiments may incorporate indirect elimination detection techniques, i.e. detecting signals that indicate, precede, follow, or otherwise characterize, correlate with, or predict the likelihood of elimination events. To indirectly sense elimination, the present systems and methods may compare one or more indirectly sensed signals with a labeled (for example, directly sensed, user-labeled, expert-labeled, or machine-labeled) set of signals from the infant and/or from aggregations of other infants. Indirect sensing may, for example, employ some or all of the following techniques and technologies, singly or in combination, to detect and/or attempt to detect elimination events in accordance with the present methods and systems:
Actigraphic, gyroscopic, or other motion sensors; for example, a first motion sensor may be connected to the trunk or waist of an infant and a second motion sensor may be connected to an extremity (such as ankle or wrist), allowing for limb movement to be measured accurately in a scenario where sleep status is being evaluated but the child's body is in motion (being carried, strolled, in car seat, and so on).
Signals from one or more cameras/imaging devices, including signals from infrared projectors and sensors, may be used to identify or predict elimination events or related data; for example, machine vision analysis may be used to detect identity, facial expression, body movements/motion capture, position, relative position in a room, interaction with persons or objects, identity of other persons, animals (pets) or objects, sleep/waking state, feeding events, emotional state, external monitoring of pulse or electrical heart activity (ECG), skin or other body temperature, skin color variation, skin tension, or detection of respiratory rate and effort.
Cardiorespiratory and Autonomic Nervous System measurements; for example, an infant's heart rate, heart rate variability, respiratory rate, respiratory effort, and other indicators of autonomic nervous system balance, e.g. sympathetic, parasympathetic, and/or enteric, may be measured through one or more of electrical activity monitoring, e.g. an electrocardiogram, impedance cardiography, transdermal monitoring, electro-dermal activity (such as skin conductance or skin potential), sub-dermal sensors, strain gauges, sensors woven/integrated into a garment, and/or remote sensing of skin color variation/thermal changes/electrical activity/respiration.
Respiration measurements, including monitoring of breathing rate and quality by chest wall excursion sensing via a wearable strap with strain gauge or other sensors, sensors woven/integrated into a garment, motion capture, acoustic interpretation, and the like.
Muscles contraction measurements, including monitoring abdominal, pelvic, bladder and bladder neck, and rectal sphincter activity through muscle tonometry, ultrasound, non-invasive electrical monitoring, and the like.
Bladder status measurements, including non-invasive monitoring of bladder fullness, urine quantities, or contraction through ultrasonography, muscle tonometry, and the like.
Acoustic measurements, including monitoring an infant's cry frequency, cry volume, cry quality, other vocalizations, breathing patterns, tone of voice, voice recognition, ambient noises, and the like.
Location monitoring, including RFID or other near-field sensing of infant location in relation to other objects (such as crib, feeding chair, car seat, stroller, etc.), locations (kitchen, bathroom, etc.), or people (siblings, caregivers, etc.) for example with RFID/NFC tags attached to these objects, in these locations, or attached to these people. The present methods and systems may also utilize GPS or similar geographic location detection, which may include geo-fencing capability, or measuring of distance from another device or location.
Remote human observation, wherein one or more humans in different physical locations than the child (“remote caregivers”) may remotely observe the child, for example over a remote video connection, and use human judgment as to when elimination may happen (or be about to happen, or have just happened).

### Exemplary Elimination Detection Routine

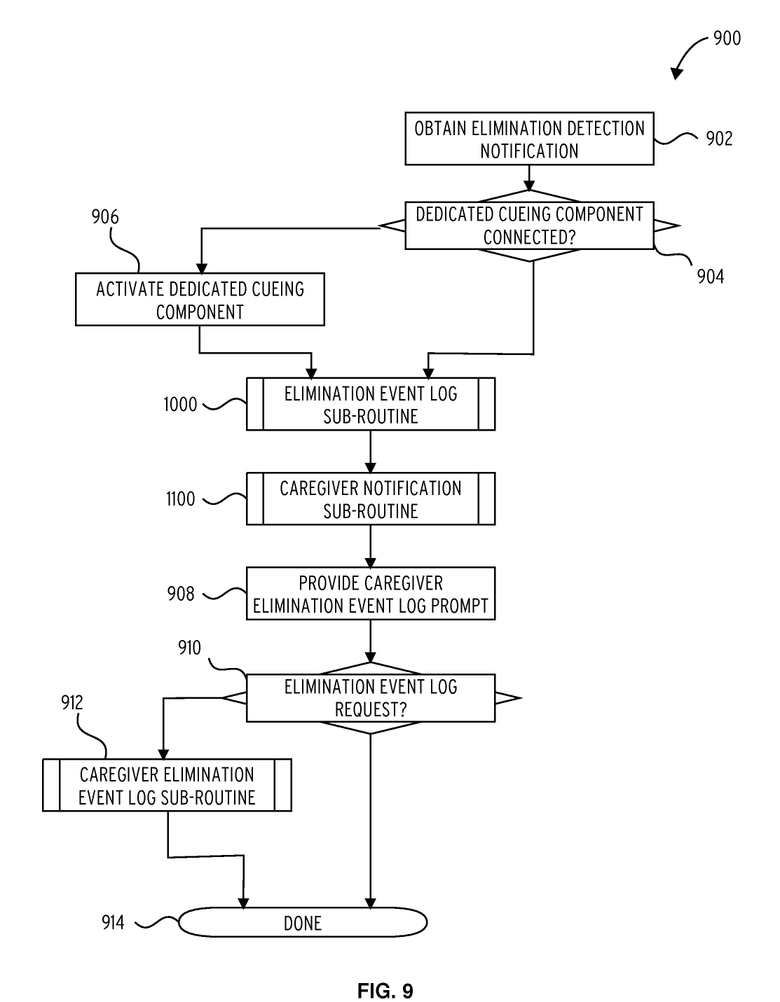

FIG. 9 illustrates an exemplary elimination detection routine 900, that may be performed by caregiver application 820 operating on caregiver monitor device 800 as part of conditioned response toilet training system 200, for example in response to an elimination detection notification obtained from diaper sensing unit 500.

Elimination detection routine 900 may obtain an elimination detection notification at execution block 902.

As is described in more detail below, various embodiments may include an optional dedicated cueing device 1300. At decision block 904, if elimination detection routine 900 if caregiver application 820 is in data communication with a dedicated cueing device 1300, then 1000 may activate dedicated cueing device 1300 at block 906; otherwise 1000 may proceed to call caregiver elimination event log sub-routine 1000.

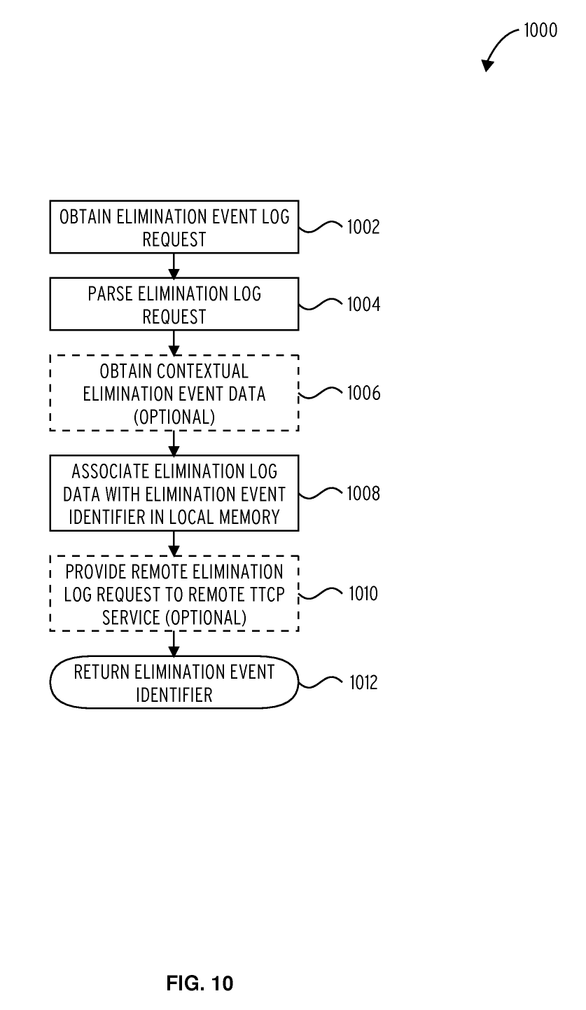

Elimination detection routine 900 may provide an elimination event log request to a caregiver elimination event log sub-routine 1000, described below in reference to FIG. 10.

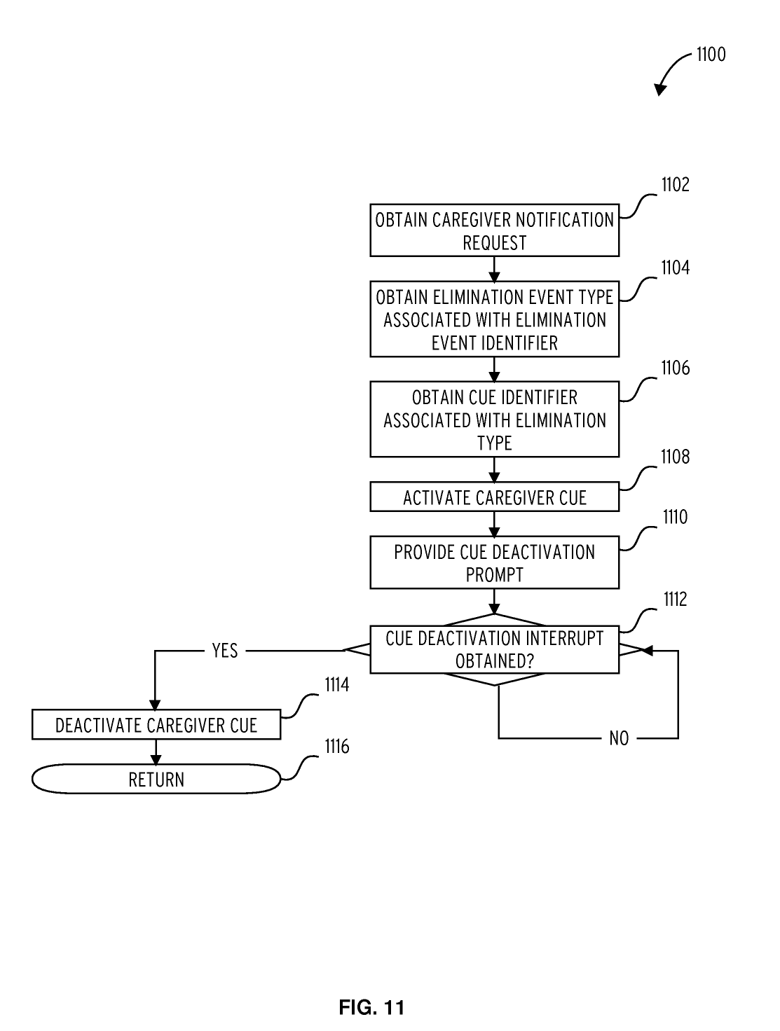

Elimination detection routine 900 may provide a caregiver notification request to a caregiver notification sub-routine 1100, described below in reference to FIG. 11.

Elimination detection routine 900 may provide a caregiver elimination event log prompt, e.g. via display (optional) 812 at block 908.

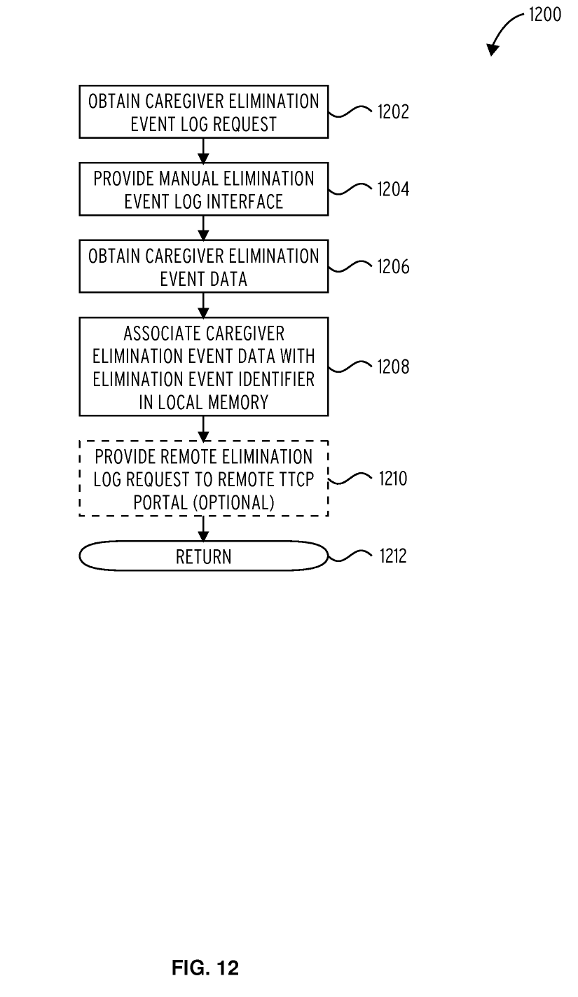

At decision block 910, if elimination detection routine 900 obtains an affirmative response to the elimination event log prompt, elimination detection routine 900 may provide a caregiver elimination event log request to caregiver elimination event log sub-routine 1200, described below in reference to FIG. 12, and then proceed to termination block 912; otherwise 900 may proceed directly to termination block 912.

### Exemplary Caregiver Elimination Event Log Sub-Routine

FIG. 10 illustrates an exemplary caregiver elimination event log sub-routine 1000, that may be performed by caregiver application 820 operating on caregiver monitor device 800 as part of conditioned response toilet training system 200, for example in response to an elimination event log request obtained from elimination detection routine 900.

Caregiver elimination event log sub-routine 1000 may obtain an elimination event log request at execution block 1002.

Caregiver elimination event log sub-routine 1000 may parse the elimination event log request to obtain elimination event data provided by diaper sensing unit 500.

In accordance with various embodiments, caregiver elimination event log sub-routine 1000 may obtain additional elimination event data, such as indirectly sensed data, aggregate data, and the like, at execution block 1006.

Caregiver elimination event log sub-routine 1000 may associate the elimination event log data with an elimination event identifier in memory 804 at execution block 1008.

In accordance with various embodiments, caregiver elimination event log sub-routine 1000 may provide a remote elimination log request to a remote toilet training community portal service, such as remote toilet training community portal service 1514, as is described in more detail below, at 1010.

Caregiver elimination event log sub-routine 1000 may return the elimination event identifier to elimination detection routine 900 at return block 1012.

### Exemplary Caregiver Notification Sub-Routine

FIG. 11 illustrates an exemplary caregiver notification sub-routine 1100, that may be performed by caregiver application 820 operating on caregiver monitor device 800 as part of conditioned response toilet training system 200, for example in response to caregiver notification request obtained from elimination detection routine 900.

Caregiver notification sub-routine 1100 may obtain a caregiver notification request, which may include an elimination event identifier, at execution block 1102.

Caregiver notification sub-routine 1100 may obtain an elimination event type associated with the elimination event identifier at execution block 1104.

Caregiver notification sub-routine 1100 may obtain a cue identifier associated with the elimination event type at execution block 1106.

Caregiver notification sub-routine 1100 may provide a caregiver cue, e.g. via display (optional) 812 and/or speaker (optional) 814, at execution block 1108.

Caregiver notification sub-routine 1100 may provide a cue deactivation prompt, e.g. via display (optional) 812, at execution block 1110.

At decision block 1112, caregiver notification sub-routine 1100 waits to obtain a cue deactivation interrupt, e.g. via user input (optional) 810, in response to the cue deactivation prompt. If caregiver notification sub-routine 1100 obtains a cue deactivation interrupt, 1100 may proceed to execution block 1114.

At execution block 1114, caregiver notification sub-routine 1100 deactivates the caregiver cue.

Caregiver notification sub-routine 1100 may return to elimination detection routine 900 at return block 1116.

### Exemplary Caregiver Elimination Event Log Sub-Routine

FIG. 12 illustrates an exemplary caregiver elimination event log sub-routine 1200, that may be performed by caregiver application 820 operating on caregiver monitor device 800 as part of conditioned response toilet training system 200, for example in response to a caregiver elimination event log request obtained from elimination detection routine 900.

Caregiver elimination event log sub-routine 1200 may obtain a caregiver elimination event log request at execution block 1202. The caregiver event log request may include an elimination event identifier.

Caregiver elimination event log sub-routine 1200 may provide a manual elimination event log interface, e.g. via display (optional) 812, at execution block 1204.

Caregiver elimination event log sub-routine 1200 may obtain caregiver elimination event data, e.g. via user input (optional) 810, at execution block 1206.

Caregiver elimination event log sub-routine 1200 may associate the caregiver elimination event data with the elimination event identifier in memory 804 at execution block 1208.

In accordance with various embodiments, caregiver elimination event log sub-routine 1200 may provide a remote elimination log request to a remote toilet training community portal service, such as remote toilet training community portal service 1514, as is described in more detail below, at 1010.

Caregiver elimination event log sub-routine 1200 may return to elimination detection routine 900 at return block 1212.

### Exemplary Dedicated Cueing Device

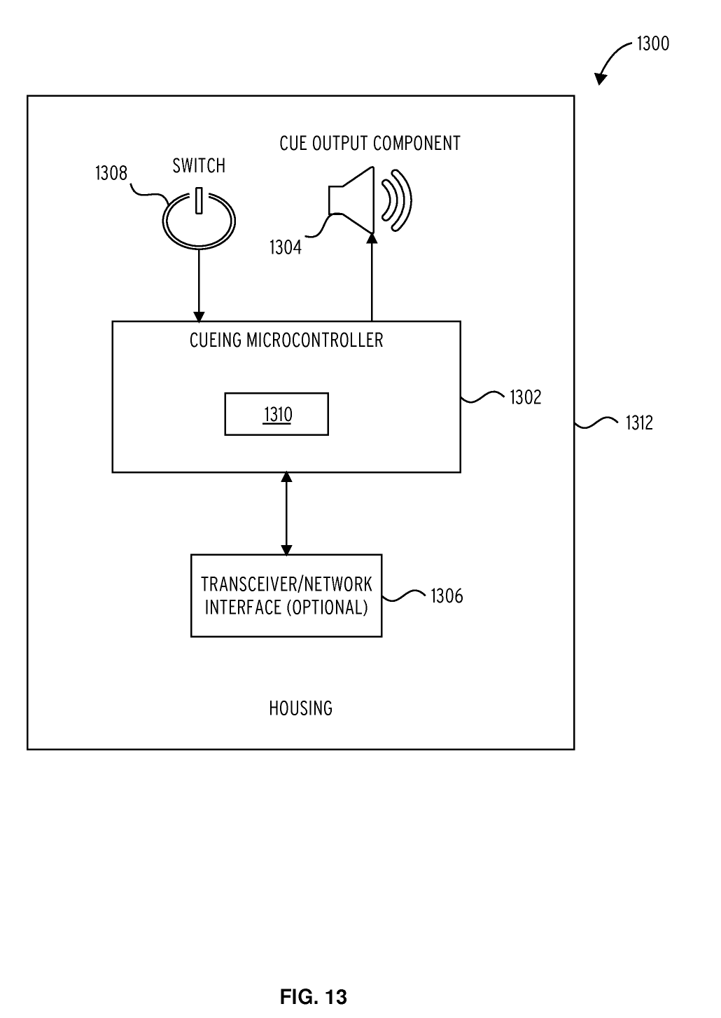

Referring to FIG. 13, several components of an exemplary dedicated cueing device 1300 in accordance with various embodiments are illustrated. Preverbal children may benefit from a device that allows them to signal their need to eliminate. Various embodiments of conditioned response toilet training system, such as conditioned response toilet training system 300, may include a dedicated cueing device, such as exemplary dedicated cueing device 1300, that supports this function, as well as other functions of the system.

A cueing microcontroller 1302 may be electrically connected to a cue output component 1304, a transceiver/network interface (optional) 1306, and a switch 1308. In other embodiments of the present conditioned response toilet training system, a dedicated cueing device may have similar internal components as caregiver monitor device 800. The components of dedicated cueing device 1300 may be enclosed in a housing 1312. Housing 1312 may be designed to be visually and physically interesting to an infant and differentiated from other objects in the infant's environment. In relatively simple embodiments, housing 1312 may be configured as a simple toy (such as a hand bell, rattle, bracelet, or musical egg) that may be worn by the child on a short tether, on the child's wrist, dangled in a crib/play area/car seat, and/or otherwise kept near the child.

In some embodiments, such as conditioned response toilet training system 300, described below in reference to FIG. 3, dedicated cueing device 1300 may also include a transceiver/network interface (optional) 1306 for wirelessly connecting to other devices and/or networks, such as diaper sensing unit 500, caregiver monitor device 800 and/or local area network 204.

Cueing microcontroller 1302 may include a processing unit (not shown) and memory (not shown) containing executable instructions for causing the processing unit to perform an embedded cueing application 1310, the functionality of which is described below.

Dedicated cueing device 1300 may establish wireless data communication with diaper sensing unit 500. In such embodiments, dedicated cueing device 1300 may serve the following purposes: activate cue output component 1304 in response to obtaining an elimination event notification from diaper sensing unit 500; provide a notification to a caregiver monitor device 800 in response to obtaining an elimination event notification from diaper sensing unit 500; provide a notification to a caregiver via cue output component 1304 when a prediction component of embedded cueing application 1310 determines there is a high likelihood that the infant needs to eliminate and the like.

In some embodiments, 1300 may include additional components, such as an accelerometer and/or a gyroscope for tracking movement of dedicated cueing device 1300. In such embodiments, if an infant waves dedicated cueing device 1300 back and forth in a particular manner, as in the American Sign Language (ASL) sign for “potty,” cueing microcontroller 1302 may cause activate cue output component 1304.

Dedicated cueing device 1300 is intended to teach infants to communicate their elimination needs to their caregivers. The caregiver may place dedicated cueing device 1300 close to the infant, or tether/attach dedicated cueing device 1300 to the infant. Depending on the infant's age and development stage, any time the infant looks at, reaches for, grabs, shakes, or engages switch 1308 on dedicated cueing device 1300, the caregiver may place the infant on an appropriate waste receptacle, such as waste receptacle 104 and provides the infant an opportunity to eliminate. In this manner, the infant may learn that engaging with dedicated cueing device 1300 leads to being placed on waste receptacle 104 and provided an opportunity to eliminate.

In accordance with various embodiments, if an elimination event is detected by any component of a conditioned response toilet training system, or if an enhanced training-toilet (described below) detects that a child is on the toilet, embedded cueing application 1310 may deliver a conditioning cue to the child via cue output component 1304, e.g. using sound (including customizable or user-recorded sound), vibrations or other haptic feedback, lights, and/or motion, and the like. Embedded cueing application 1310 may also provide a notification to a caregiver via sound, light, vibration, text message, caregiver monitor device 800, and the like.

Embedded cueing application 1310 may carry out some or all of the conditioned response toilet training system's elimination prediction functionality, described below. If embedded cueing application 1310 determines a likelihood of elimination within a certain time window exceeds a defined threshold, the embedded cueing application 1310 may provide a notification to a caregiver and/or activate cue output component 1304 in order to cue the child.

A caregiver may use dedicated cueing device 1300 to cue a child to eliminate, or as the child eliminates, e.g. by activating switch 1308.

A child may be conditioned to use dedicated cueing device 1300 by having a caregiver manually activate cue output component 1304 when the child is eliminating (in a diaper or on a toilet), and/or by bringing the child to the toilet each time the child interacts with, activates, or otherwise expresses interest in dedicated cueing device 1300.

Depending on the developmental stage and toilet training status of a child, dedicated cueing device 1300 may activate cue output component 1304 in response to behavior of the child that changes over time in order to shape the child's communication into a desired form, for example the ASL sign for “potty.” For example, for young children, dedicated cueing device 1300 may activate 1304 when dedicated cueing device 1300 is touched or shaken; as the child develops, dedicated cueing device 1300 may activate cue output component 1304 only as the motion of dedicated cueing device 1300 more closely resembles the ASL sign for “potty.”

### Exemplary Embedded Elimination Cueing Routine

FIG. 14 illustrates an exemplary embedded elimination cueing routine 1400, that may be performed by embedded cueing application 1310 operating on dedicated cueing device 1300 as part of conditioned response toilet training system 300, for example in response to an elimination detection notification obtained from diaper sensing unit 500 or caregiver monitor device 800, depending on the configuration of a particular embodiment.

Embedded elimination cueing routine 1400 may obtain an elimination detection notification at execution block 1402.

Embedded elimination cueing routine 1400 may activate cue output component 1304 at block 1404.

At decision block 1406, embedded elimination cueing routine 1400 waits for a cue interrupt. If embedded elimination cueing routine 1400 obtains a cue interrupt, for example via a user activating switch 1308, embedded elimination cueing routine 1400 may proceed to execution block 1408.

Embedded elimination cueing routine 1400 may deactivate cue output component 1304 at execution block 1408.

Embedded elimination cueing routine 1400 may end at termination block 1410.

### Data Collection

Various components of the present conditioned response toilet training systems and methods described above may record aspects of an infant's elimination patterns and possibly other data that are sensed (such as motion or location), user-input (such as feeding), or inferred (such as sleep). This enables the prediction component of the present systems and methods to identify times when the likelihood that the infant will eliminate exceeds a threshold, at which point the signaling component prompt a caregiver (or caregivers), e.g. via a signal on the diaper's electronic module, a signal on a smartphone or watch or other wearable device, or a separate, dedicated caregiver electronic device, so that a caregiver may closely observe the infant and consider placing the infant on a waste receptacle 104 and providing a cue. Therefore, various embodiments of the present conditioned response toilet training systems and methods enable the gathering, recording, communicating, and processing of various data relating to an infant's eliminations, including explicit data, implied/derived data, and/or aggregated data.

The ability of a given embodiment of the present systems and methods to collect, store, communicate, and analyze various types of data will depend on the capabilities and configuration of the embodiment. For example, as will be apparent from the drawings and accompanying description, exemplary conditioned response toilet training system 400 is capable of collecting, storing, communicating, and analyzing a greater variety of data than exemplary conditioned response toilet training system 100. Depending on the embodiment, data may be collected by, stored on, communicated between, and analyzed by: diaper sensing unit 500, caregiver monitor device 800, dedicated cueing device 1400 and/or remote server 1600, as well as other networked computing devices (not shown), which may have form factors including general purpose computers (including “desktop,” “laptop,” “notebook,” “tablet” computers, or the like); servers; mobile phones; watches, glasses, or other wearable computing devices; dedicated media players; motor vehicle head units; audio-video on demand (AVOD) systems; dedicated media consoles; or the like. Various embodiments contemplate data communication among various devices using both wired data transfer and a variety of wireless communication protocols such as Bluetooth or Bluetooth LE, Zigbee, Ant, 802.11, mobile telephone networks, and the like.

Explicit data may include the timing of various events, event values, and values derived or calculated or otherwise processed from this data), such as the following:
Values of all signals used to directly or indirectly detect elimination events, as described above, and all calculations, transformations, or other derivations of such data.
Device battery state for battery-powered devices.
Connection/disconnection events between the diaper sensing microcontroller 502, diaper 102, and elimination detection component 504.
Diaper weight, if for example used diapers or diaper liners are weighed after elimination events, for the purposes of calculating the weight and/or volume of effluvia. In one embodiment, caregivers manually weigh diapers or diaper liners prior to disposal (if disposable) or other storage (if reusable). In another embodiment, diapers are disposed of in an enhanced waste receptacle, described below, or other receptacle that detects weight changes and stores these and communicates them to other parts of the system.
Volume or weight or other properties of urine and feces, if for example the child eliminates on an enhanced training-toilet.
Any additional data collected by an enhanced training-toilet, described below.
Signaling events, such as child conditioning, caregiver notification, cueing, child communication, and prompting, and any other events triggered by child or caregiver interaction with the system.
Caregiver-entered data such as quality or quantity of effluvia (for example urine vs. feces, or the nature of the feces), feeding (type, onset, completion, etc.), sleeping (type, onset, completion, etc.), cueing success/failure, elimination detection success/failure, and confirmation or correction of system data, for example if a caregiver corrects a false positive or false negative detection event. Caregivers can enter data either via controls on the diaper sensing unit 500, caregiver monitor device 800, a smartphone, smart watch, or other wearable device, an enhanced training-toilet, a web application, or a home electronic/automation system. In some embodiments, the caregiver data entry interface includes voice/speech inputs. In other embodiments, the caregiver data entry interface involves email, SMS, or mobile phone notifications.
System-related events such as a caregiver connecting or disconnecting their smartphone, smart watch, or other wearable device to diaper sensing unit 500, or diaper sensing unit 500 detecting the presence or absence of one or more connected caregiver devices.
Location of child(ren) or caregiver(s), either absolute, in relation to each other (proximity), a toilet, or other defined areas of a caregiving environment.

Implied/derived data may include:
Implied success/failure data, for example:
   A detected elimination that is not followed by a diaper or diaper liner change within a certain time window suggests either a false positive detection or that the caregiver was unable to change the diaper (for example during a car trip).
   A diaper or diaper liner change that was not preceded by a detected elimination event within a certain time window suggests a false negative detection.
   When diaper changes occur, the duration of the diaper change (as measured from the time from the silencing of the conditioning stimulus or the diaper disconnect to the attachment of a new diaper) may be used to infer urine vs. stool events, as wiping/cleanup time with stool is longer.
   If the caregiver applies the cueing stimulus to the child and this is followed by an elimination detection and diaper change within a certain time window after the cueing event, it suggests that the cueing was unsuccessful. Conversely, a prolonged period with no diaper change, no detected elimination events, and multiple cueing events suggests that the child is successfully eliminating on the toilet when prompted.
   Similarly, the system may automatically identify cueing success or failure when an enhanced training-toilet equipped to measure the presence or absence of elimination is used, by determining whether or not a cueing event was followed by elimination within a certain time window.
Caregiver behavioral data, for example:
   The time from an elimination detection event to the next diaper or diaper liner change.
   The time from an elimination detection event to the cessation of the cue.
   Direct caregiver input, i.e. the caregiver may inform a component of the conditioned response toilet training system directly when the child has been brought to the toilet, for example by pressing a button or via a speech/voice interface.
   In another embodiment, the system uses RFID/NFC to identify when the child has been brought to the toilet.
   In another embodiment, the system uses GPS, Wi-Fi, or other signals to identify when the child has been brought to the toilet.
   In another embodiment, the system uses machine vision to identify when the child has been brought to the toilet.
   In another embodiment, the toilet is itself equipped to detect when the child has been brought to the toilet (e.g. an enhanced training-toilet, described below).
Data on caregiver usage of the system, for example:
   Embodiments of the present systems and methods may recognize how often it is in use by monitoring when diapers are connected and disconnected from diaper sensing unit 500.
   Embodiments of the present systems and methods recognize when the caregiver/child have moved beyond using diapers by observing no diaper connect/disconnect events, but continued use of diaper sensing unit 500 (or a dedicated cueing device, or smartphone, or smart watch, or other wearable) to cue the child.
   The system can recognize how often different caregivers use the system by detecting when a particular caregiver is “connected”, i.e. a caregiver monitor device 800 associated with a particular caregiver is paired with diaper sensing unit 500.

Aggregated data may include a store of data, public or anonymized, from various users of the system, including both caregivers and children, and of every type mentioned above, including direct sensing data, indirect sensing data, diaper or diaper liner connection or disconnection data, explicit data, implicit data, system data, caregiver data, child data, and the like. The system may further analyze this data to develop a set of age- gender-, and child-specific “norms” for elimination patterns, possibly in relation to feeding, sleeping, or other data, system usage patterns, toilet training patterns, and the like.

These data may be used to improve the accuracy of elimination prediction, or to help solve toilet training problems or for other related purposes.

### Elimination Prediction

In accordance with various embodiments of the present conditioned response toilet training systems and methods, techniques for predicting when the child is likely to eliminate are provided.

In the early stages of the present conditioned response toilet training systems and methods, elimination prediction techniques enables caregivers—who may be busy, multitasking parents or day care providers—to identify time periods during which they should closely observe the child's behavior and physical presentation in order to learn the child's pre-elimination patterns. Later in the training process, the elimination prediction techniques helps caregivers identify the best moments to provide the child an opportunity to eliminate, increasing the number of elimination opportunities that result in a successful elimination event, thereby saving time. The elimination prediction techniques may also enable caregivers to provide elimination opportunities while disrupting caregiver and child sleep patterns as little as possible.

Depending on the configuration of the conditioned response toilet training system, the elimination prediction techniques may be implemented by suitably adapted embodiments of embedded elimination detection and cueing application 520, caregiver application 820, embedded cueing application 1310, and or a remote software service (described below). To maximize battery life in embodiments in which prediction calculations are carried out on a battery-powered device such as diaper sensing unit 500 or a dedicated cueing device 1300, the prediction system may change the frequency with which it estimates elimination likelihood based on the previous estimated likelihood or other factors. For example, the elimination prediction techniques may estimate elimination likelihood rarely during the time window immediately following elimination, and more frequently as the estimated likelihood of elimination increases over time.

The prediction techniques may take the following data as inputs:
Any data the system gathers, uses, generates, implies, derives, or computes, as mentioned above.
Any data the caregiver may enter, including caregiver feedback on the prediction system output or desired prediction system performance, such as tradeoffs between precision and recall (see below).
Additional data such as weather, temperature, location, motion, etc.
Profile information for the child, including birth date/age, height, weight, gender, ethnicity, languages spoken, home address, any relevant medical conditions, child temperament, feeding status (breastfeeding/formula/combined, information on other foods, feeding schedule), sleep configuration such as where infant and caregivers sleep, parental marital status, other information about the parents or custodians/guardians, etc.
Profile information for siblings or other relevant children, including relationship to the child, toilet training status and history, and the factors above.
Profile information for the caregiver(s), including age, gender, relationship to the child, relationship to the other caregivers, number of children currently training (as for example with day care staff or a nanny, or caregivers with twins/triplets/etc. or other multiple children being concurrently trained), ethnicity, languages spoken, home address, parental experience, toilet training experience, education, income, profession, etc.
Information for the overall toilet training context, for example the desired training schedule (e.g. 4 hours per day, 5 days a week), the number of caregivers, the schedule of caregivers, the age at which training began, the type of diapers or other absorbent clothing being used, the type and location of the waste receptacle(s), the physical context (information about the home, day care, or other commonly visited locations), information about other children in the environment that may be training concurrently, information about a day care or other similar environment, such as the number, age composition, and toilet training status of the other children, etc.
Aggregations of all the data mentioned above, including system data and individually attributable or anonymized data from other children, caregivers, and/or siblings, including both data obtained from users of the system and data obtained through other means, and including all profile and toilet training context data described above.
Additional related data, such as scientifically published or otherwise obtained data on age and gender norms for elimination frequency, feeding frequency, sleep patterns, movement patterns, and the like.
Additional data on bladder control development, such as bladder capacity, coordination between bladder and detrusor muscles, and voiding completion/post-void residual urine. This may include but is not limited to measurements of voiding frequency and interrupted voiding patterns, urination during sleep, measurements or estimates of urine output, ultrasound or other non-invasive measurements of bladder capacity and urine volume (pre- and post-voiding), lowest bladder volume triggering micturition, and emptying ability. Such data may be derived from analysis of voiding intervals, voiding volume, characteristics of urine stream (flow patterns) determined from visual, acoustic, or other means, or from intermittent use of bladder ultrasonography or similar non-invasive imaging of bladder volumes pre- and post-elimination. Aspects of bladder control development may be predicted from norms based on age, gender, ethnicity, and toilet training progress. Measured, estimated, or predicted bladder control data may inform training protocol and prediction algorithms.

Generally, the prediction techniques compares current or recent data specific to a single child (including all related data, whether recent or not and whether about the child or not), or representations or transformations of this data, with some reference data, or representations or transformations or models derived from the reference data, to estimate the likelihood that the child will eliminate within a given future time period and identify when this likelihood exceeds a certain threshold. Both the reference data and the processing algorithm may be pre-set and unchanging, or may be updated as the child ages, grows, reaches various toilet training and other milestones, and the like.

The prediction system may use only reference data that is collected or input or derived only from the specific child/caregiver using the system, or may use as reference data aggregate data from many other children and caregivers, or input or obtained through other means, or a combination of these.

The prediction system may be user-configurable, for example enabling caregivers to set the desired prediction time window, or to trade off precision (the fraction of predicted eliminations that are correct) and recall (the fraction of elimination events that are correctly predicted) so as to optimize the balance of training performance and convenience. In another embodiment, the system automatically self-configures to adjust the desired prediction time window or to set a given desired balance between precision and recall. For example, the prediction system may tune itself to maximize variables such as caregiver retention and usage of the system, or caregiver/child progression towards specific training goals or milestones.

Both the inputs and outputs of the elimination prediction techniques may be aggregated across and communicated between any of the components of the conditioned response toilet training system. For example, the current or recent data about a child's eliminations may be collected and the elimination prediction techniques applied by diaper sensing unit 500 or the elimination data may be collected by diaper sensing unit 500, then communicated to a caregiver device 800, then communicated to a remote server 1500 (described below in reference to FIG. 15), and the elimination prediction techniques provided by a remote software service. The results of the elimination prediction techniques may then be communicated back to caregiver device 800.

### Exemplary Remote Server

Referring to FIG. 15, several components of an exemplary remote server 1500 are illustrated. In some embodiments, a remote server 1500 may include many more components than those shown in FIG. 15. However, it is not necessary that all of these generally conventional components be shown in order to disclose an illustrative embodiment. As shown in FIG. 15, exemplary remote server 1500 includes a processing unit 1502 in data communication with memory 1504 via a bus 1506. Memory 1504 generally comprises some or all of random access memory (RAM), read-only memory (ROM), and/or a permanent mass storage device, such as a disk drive, flash memory, or the like. Remote server 1500 may also include a network interface 1508 for communicating with other computing devices via a network, a user input (optional) 1510, a display (optional) 1512. Note that some embodiments of a remote server may utilize more than one bus to provide data communication between the remote server's various hardware components, e.g. a memory bus connecting the processing unit to the memory and an I/O bus connecting the processing unit to the network interface, the user input, and/or the display.

Memory 1504 of exemplary remote server 1500 may store an operating system 1514, as well as program code for a number of software services, described below. These and other software components, as well as various data files (not shown) may be loaded into memory 1504 via network interface 1508 (or via a selectively removable computer readable storage medium 1516, such as a memory card or the like). Remote server 1500 may also communicate via bus 1506 and/or network interface 1508 with one or more data stores, such as data store 402.

In operation, operating system 1514 manages the hardware and software resources of remote server 1500 and provides common system services for the various software services executing on remote server 1500. For hardware functions such as network communications via network interface 1508, obtaining data via user input (optional) 1510, rendering data via display (optional) 1512, allocation of memory 1504 to various resources, and the like operating system 1514 may act as an intermediary layer between software services executing on remote server 1500 and the client device's hardware.

Although an exemplary remote server 1500 has been described, any of a great number of computing devices capable executing program code, such as the program code corresponding to operating system 1514 and the software services described below. In some cases, the functionality of remote server 1500 may be embodied by one or more replicated and/or distributed physical or logical devices. In cases, one or more instantiations of remote server 1500 may be embodied by the same physical device.

In accordance with various embodiments of the present conditioned response toilet training system, such as conditioned response toilet training system 400, memory 1504 may include program code for a remote toilet training community portal service 1518. Remote toilet training community portal service 1518 may act as an interface between a client application, such as browser application 818 and/or caregiver application 820, and various other services provided by the components of the present conditioned response toilet training system, such as remote toilet training system data collection service 1520; remote toilet training system data analytic service 1522; remote toilet training facilitation service 1524; remote caregiver prompting service 1526; remote caregiver education service 1528; remote user collaboration service 1530; and e-commerce service 1532. Remote toilet training community portal service 1518 may also act as a user account manager. In various other embodiments of the present conditioned response toilet training system that do not include remote server 1500, such as conditioned response toilet training system 200 and/or conditioned response toilet training system 400, the functionality of many of the remote software services may be performed locally by suitably adapted embodiments of embedded elimination detection and cueing application 520, caregiver application 820, and/or embedded cueing application 1310.

### Remote Toilet Training System Data Collection Service

Remote toilet training system data collection service 1520 may obtain remote elimination log requests, e.g. from a caregiver application 820, a dedicated cueing device 1300, or the like, including user related data, an elimination event identifier, and data related to an elimination event. Remote toilet training system data collection service 1520 may parse the data contained in the remote elimination log requests and provide corresponding data to data store 408.

Remote toilet training system data collection service 1520 may also provide tools for caregivers to correct errors in the data, such as false positives and false negatives in the detection and/or prediction components.

Remote toilet training system data collection service 1520 may also provide tools for caregivers to enter demographic and other relevant profile information.

Remote toilet training system data collection service 1520 may also provide tools for soliciting or prompting the caregiver to clarify a data point or enter or describe events.

In accordance with various embodiments, remote toilet training system data collection service 1520 may obtain data from browser application 818, caregiver application 820, caregiver monitor device 800, a general purpose computing device, email, SMS message, wearable computing device, diaper sensing unit 500, enhanced training-toilet (described below), or other component of a conditioned response toilet training system.

In accordance with various embodiments, data may be stored on a local device and provided to 1520 either in “real-time” or at a later time.

### Remote Toilet Training Analytic Service

Remote toilet training system data analytic service 1522 may enable users of a conditioned response toilet training system, such as conditioned response toilet training system 400, to collect, interact with, enter, analyze, confirm/verify, correct, add to, annotate, share, and interpret data captured, created, or otherwise used by the conditioned response toilet training system, such as remote toilet training system data collection service 1520.

This could include data on the frequency of eliminations, the percentage of “successful” eliminations (i.e. eliminations completed via a toilet rather than in a diaper), the time between elimination detection and the child being placed on the toilet, and the like. The portal may also provide a means whereby caregivers can correct errors in the data, such as false positives and false negatives in the detection and/or prediction components.

### Remote Toilet Training Facilitation Service

Remote toilet training facilitation service 1524 may determine, suggest, facilitate the execution of, update, and/or modify a toilet training protocol for a child and associated caregiver(s). An initial training protocol, and associated products and advice, for a child of may be selected based preliminary data similar the prediction inputs, described above, such as demographic data, aspects of the child's feeding schedule, and the like.

Aspects of a child's training protocol that may vary based on the preliminary data include:
A suggested configuration of various other components in the conditioned response toilet training system that may be used with the child, such as diaper sensing unit 500, caregiver monitor device 800, dedicated cueing device 1300, an enhanced training-toilet (not shown, described below), and/or an enhanced waste receptacle (not shown, described below).
A suggested type, size, and number of diapers and/or diaper liners.
A suggested configuration of elimination detection component 504, e.g. a particular sensor configuration.
A suggested conditioning cue.
Suggested ways for the child to signal its desire or need to eliminate.
A suggested training-toilet type/model, number of training-toilets, and location of the training-toilet(s) in the child's environment.

Remote toilet training facilitation service 1524 may also provide a suggested method for teaching toilet training techniques to the child based on one or more caregiver's preferences, learning style, experience, educational background, reading level, socio-economic status, cultural and ethnic background, available computing devices/internet access, and the like.

Remote toilet training facilitation service 1524 may also provide caregivers tips, reminders, check-ins, game design, achievements, and the like, intended to encourage caregiver and/or child participation in the toilet training process.

A child's ongoing toilet training protocol may be modified based on collected data and the results of remote toilet training system data analytic service 1522. For example, if remote toilet training system data analytic service 1522 determines a child has reached a new stage in toilet training, remote toilet training facilitation service 1524 may modify the child's training protocol based on the requirements of the next stage of toilet training. By way of further example, if remote toilet training system data analytic service 1522 determines a child appears to be stalled, resisting, or regressing in training, remote toilet training facilitation service 1524 may provide caregivers with specific remedial suggestions and/or may modify the child's training protocol. By way of further example, in embodiments including machine vision or video recording capabilities, remote toilet training facilitation service 1524 may collect, identify, tag and compile the audio and video of a child pre-elimination for caregiver review, e.g. in order to teach caregivers a child's specific pre-elimination cues, which may be helpful in multiple caregiver scenarios.

### Remote Caregiver Prompting Service

Remote caregiver prompting service 1526 may provide prompts and/or reminders to caregivers to implement the training protocol, for example by reminding caregivers that a particular day or time window is a “training day (or time)”. These reminders may be delivered via: caregiver monitor device 800, through caregiver application 820, browser application 818, and/or another client application (not shown); email; text message; “push” notification, diaper sensing unit 500, and the like.

Remote caregiver prompting service 1526 may provide tracking tools allowing caregivers to track progress against goals and milestones, either user-established or system-generated. Remote caregiver prompting service 1526 may employ game mechanics such as badges, points, leader boards, and similar techniques designed to encourage caregivers to persist and succeed with the toilet training. Remote caregiver prompting service 1526 may interact with users' social media accounts to post updates and successes. As an example, couples or associated caregivers may find themselves in friendly competition against each other to notice and respond to pre-elimination cues to maintain the lowest “miss” rate, or caregivers may be able to view benchmarks so that they can understand how they compare to other similar caregivers along various measures.

Remote caregiver prompting service 1526 may provide diagnostic tools to identify areas for improvement and to provide the appropriate recommendations to caregivers. Remote caregiver prompting service 1526 may be capable of measuring success of protocols, advice, and encouragement on an individual and/or group caregiver level, and adjusting an encouragement approach accordingly.

The following are examples of remote caregiver prompting service 1526 that may be tuned on an individual and/or group level to maximize caregiver retention and child progression towards known training goals/milestones:
Initial advice
Prompts
Delivery of information (text, email, alerts, videos, message boards, etc.)
Educational content viewed
Trouble-shooting advice
Most motivating factors and means of delivery
Progress through stages with least amount of caregiver effort, time, and cost
Signs of resistance or regression from child, and how to best avoid and/or deal with these
Ways to prevent and help with caregiver frustration, fatigue, dropout

### Remote Caregiver Education Service

Remote caregiver education service 1528 may provide tools for caregivers to learn more about the present systems and methods, which may reflect a new and possibly unfamiliar way to toilet train. Remote caregiver prompting service 1526 may provide access to articles on toilet training and related topics, either expert-reviewed or added by users; instructional videos; electronic books; and the like. In various embodiments, the educational content may be customized based on various parameters, such as demographic information, toilet training status, relevant medical or other issues, and the like.

### Remote User Collaboration Service

Remote user collaboration service 1530 may provide tools designed to enable caregivers of different children and others to collaborate with one another. Collaborators may include: other caregivers of their child, such as partners, nannies, or child care staff; other parents; toilet training peer or professional coaches; health care professionals, such as pediatricians, urologists, gastroenterologists; and technical/customer support staff.

Remote user collaboration service 1530 may provide tools for enabling caregivers to selectively opt in to sharing anonymized or personally identifiable data captured or created or otherwise associated with their use of the conditioned response toilet training system, including profile data such as location, age, gender, and any other data collected by components of the conditioned response toilet training system. Caregivers and other collaborators may control privacy settings, anonymous or personally identifiable status, and access differently for different data elements. Remote user collaboration service 1530 may then use this data to match caregivers to peers or professionals who have experience with children of similar age; with similar demographics; with similar elimination patterns; at similar toilet training stages; with similar sleep, feeding, temperament, or behavioral issues; with similar associated medical or developmental problems (such as but not limited to vesicoureteral reflux, neural tube defects, urge incontinence or other bladder control problems, autism, and so on); with similar issues, such as twins/triplets; with similar barriers to success; and the like. Remote user collaboration service 1530 may also use this data to connect caregivers to experts, professional trainers, health care providers, technical/customer support staff, or “expert caregivers” who have demonstrated a particular willingness to help others and who have for example encountered a particular problem and found a solution.

In various embodiments, remote user collaboration service 1530 may invite caregivers to join small collaboration groups with other similar caregivers, e.g. to attempt to create a closed, safe, less intimidating and more intimate collaborative environment.

### Remote e-Commerce Service

Remote e-commerce service 1532 may provide an online store or to enable caregivers to purchase sensor-equipped diapers, and other components of the present conditioned response toilet training system, suitable clothing, other accessories, books, videos, and the like. Remote e-commerce service 1532 may determine when a caregiver/child's diaper supply is low, e.g. by querying remote toilet training system data analytic service 1522 to determine a child's elimination frequency, estimate an associated number of diapers consumed, and compare the number of consumed diapers to a number of previously purchased diapers, and automatically order new supplies (such as new diapers or liners). Remote e-commerce service 1532 may determine when a caregiver/child are ready for a different product or line of products based on evidence of progression in training (or lack thereof), and suggest purchase of such product(s).

### Enhanced Training-Toilet

Various embodiments of the present systems and methods may include an enhanced training-toilet designed to facilitate effective toilet training. Such an enhanced training-toilet may incorporate the functionality of one or more components of conditioned response toilet training systems 100-400 and/or perform one or more of the functions described below.

The enhanced training-toilet may detect elimination events, for example in embodiments in which elimination detection is achieved using machine vision, sound, or any other indirectly sensed signal that may be sensed using sensors and electronics deployed in or in conjunction with the enhanced training-toilet. For example, the enhanced training-toilet may contain acoustic, visual, temperature, and infrared sensors, or be connected to other such sensors deployed in the same physical space with the enhanced training-toilet. The enhanced training-toilet may also detect elimination events that occur on the enhanced training-toilet, for example with similar detection techniques to those used by the system to detect diaper-based eliminations, or through other techniques such as measuring changing weight, capacitance, or other properties of the enhanced training-toilet as it fills with elimination products, as described further below.

When an elimination event is detected, either by the enhanced training-toilet or any other component of an embodiment of the present conditioned response toilet training system, the enhanced training-toilet may deliver the conditioning cue to the child, using sound, vibrations, lights, motion, or a combination of these, as described further below. The enhanced training-toilet may also notify the caregiver using any of the signaling means already described for this purpose, such as sound, light, vibration, text message, in-app notification to a mobile device, and the like.

The enhanced training-toilet may reward successful eliminations by producing sound/light/motion/haptic/spoken feedback, or dispensed rewards. Successful use of the enhanced training-toilet can automatically alert nearby caregivers of the need to empty/clean/reset the enhanced training-toilet.

The enhanced training-toilet may carry out some or all of the prediction functions, described above. When the prediction system identifies that the child's likelihood of eliminating within a certain time window exceeds a certain threshold, the enhanced training-toilet may prompt both the caregiver and the child that it may be time to use the enhanced training-toilet soon.

The caregiver may use the enhanced training-toilet to cue the child to eliminate, or as it eliminates. This may be achieved by pressing a button or activating some other type of switch, either mechanical or electronic (for example capacitive), on the enhanced training-toilet, issuing a voice command, issuing a command from a smartphone that is then relayed to the enhanced training-toilet, and the like. In various embodiments, the cue to eliminate may be activated when the enhanced training-toilet detects that the child is seated upon it, either through a machine vision system or a mechanical switch or electronic or optical sensor on the enhanced training-toilet.

The enhanced training-toilet may detect child interest in elimination or child interest in, engagement with, or interaction with the enhanced training-toilet using various techniques such as:
Using machine vision to track gaze, facial expression, gestures, postures, skin tension, and/or motion of one or more children in the room relative to the enhanced training-toilet. This may include visible and e.g. infrared imaging. The machine vision equipment may be built into the enhanced training-toilet, or deployed in a separate related or connected device that communicates with the enhanced training-toilet from a better vantage point.
Using special visual markers designed to enable a machine vision system of the enhanced training-toilet to easily detect its presence and determine its position and orientation, both relative to the room and to a child. Such special visual markers, affixed to child (or child's clothing, or accessories such as bracelet) or to dedicated cueing device 1400 may also be utilized to recognize when the child makes a particular gesture, such as American Sign Language for “potty” or other similar gesture.
Using audio monitoring for specific vocal/verbal cues from child or caregiver, or for audio signals emitted by diaper sensing unit 500, dedicated cueing device 1400, other some other device related to the conditioned response toilet training system.
Using RFID, NFC, or similar technology to determine the identity of the child or caregiver, approach to and/or distance from the enhanced training-toilet, sitting, and departure.
Detecting and responsively activating to touch, button press or other actuation, or being jostled/grabbed by the child, or when the child is seated on the enhanced training-toilet. For example, if the enhanced training-toilet (or any other component of the conditioned response toilet training system detects that the child has expressed interest in the enhanced training-toilet, or if the prediction system identifies that the child exceeds a certain likelihood of elimination, the enhanced training-toilet may invite the child to approach, for example with appealing visual, light, motion, haptic, and/or auditory cues and also alert the caregiver, e.g. via caregiver monitor device 800. Such cues relatively subtle at first and become relatively more rewarding/noticeable as the child reaches for, approaches, or otherwise expresses heightened interest in the enhanced training-toilet.
If a dedicated cueing device 1400 was triggered by the child, there may result a pleasing synchrony or “duet” between the dedicated cueing device 1400 and the enhanced training-toilet. These cues may also alert a nearby caregiver of the child's demonstrated interest, and/or trigger an alert to the caregiver using any signaling means already described, such as with a notification to a caregiver monitor device 800.

The enhanced training-toilet may be capable of detecting elimination events, recording elimination event data, and rewarding results. For example, the enhanced training-toilet may include buttons or other input mechanisms through which the caregiver can input data on types and/or qualities of resultant eliminations, or lack thereof. The enhanced training-toilet may “ask” the caregiver about results and analyze spoken responses, or “listen for” verbal feedback.

The enhanced training-toilet may detect the presence, qualities, and/or amount of elimination products, which can help identify successes and failures, aid prediction, and provide other useful data to the system using techniques such as:
Electrical sensing (resistance, capacitance), light sensing, or temperature sensing.
Sensors that measure the presence of a seated child can also measure the weight of eliminated urine or stool.
Visual analysis can capture qualitative (color, consistency, shape, caliber, Bristol scale) or quantitative (estimated volume using visual analysis or graduated markings at the bottom of the enhanced training-toilet insert) data
Qualities of the urine stream (velocity, duration, interrupted vs steady) may also be recorded; desirable qualities (such as, but not limited to relaxed, uninterrupted, and/or complete voiding) may be reinforced through feedback.

A conditioned response toilet training system incorporating an enhanced training-toilet may have flexible design aspects to allow for use in a variety of configurations and scenarios:
The enhanced training-toilet can be a standalone unit, or a design that fits onto a standard toilet in a fashion that adapts the toilet for infant/toddler use, with the ability to be placed on a stand in other rooms at other times.
The enhanced training-toilet may include a removable part comprising any number of the above detection/prediction/communication/signaling features that can be placed atop a standard toilet.
In some use scenarios such as day-care, or other child care settings where multiple children may be at various stages of toilet training, and caregivers may be too distracted to notice pre-elimination cues and interest in, or use of, the enhanced training-toilet is the hub of the toilet training system, relying less on child- or caregiver-associated devices.

A conditioned response toilet training system incorporating an enhanced training-toilet may benefit an early toilet training program at least by (1) assisting a very young child learn to communicate its interest in elimination, and reinforce the enhanced training-toilet as the place where elimination happens, by identifying and rewarding enhanced training-toilet gaze/reach/movement towards/verbal request/gesture/etc. and/or (2) allowing the use of demonstrative training dolls interacting with the enhanced training-toilet in ways that teach and reinforce desired child behaviors.

### Enhanced Waste Receptacle

An enhanced waste receptacle is a receptacle for disposing of or otherwise storing soiled diapers or diaper liners. It various embodiments, the enhanced waste receptacle may contain a sensor for weighing its contents, so that for example it can estimate the weight of elimination products in each soiled diaper. An enhanced waste receptacle may contain an RFID or similar wireless reading device, or a barcode scanner or other similar imaging device, enabling the enhanced waste receptacle to identify and count diapers as they enter it, provided those diapers are correspondingly tagged or marked. Compatible diapers may be tagged with RFID or similar tags or visual stickers. In some use cases every diaper deposited in the enhanced waste receptacle may be tagged or visually marked, and in other cases only a subset of diapers deposited in the enhanced waste receptacle may be tagged or visually marked, so that the system may provide reasonable accuracy without excessive cost. In a further embodiment, packs of diapers may be sold in packaging designed such that the diapers are removable in a predictable, predefined order, and only one or a small number of diapers are tagged or labeled, such that the enhanced waste receptacle may track diaper usage and identify the appropriate time for re-ordering, either automatic or manual, by detecting the disposal of the tagged or visually marked diapers.

### Consumables

Various unique soft goods, consumables, diapers, diaper liners, garments, and accessories (collectively, “consumables”) may be provided in conjunction with the present conditioned response toilet training systems and methods to facilitate effective, convenient, and inexpensive toilet training. Such consumables may be optimized to take advantage of the unique aspects of present conditioned response toilet training systems and methods. i.e. consumables that support only one “miss” or elimination event, with the expectation that the child will be changed quickly after elimination occurs. At the same time, such consumables may include options for overnight use, travel, or other scenarios in which more, and longer-term absorbency may be required.

In embodiments of the present conditioned response toilet training systems and methods that directly detect elimination via an elimination detection component 504, as described above, it is important that eliminations are detected quickly and accurately. To achieve this, disposable or cloth diaper liners that are designed to facilitate the rapid flow of urine or other elimination products to, or near, elimination detection component 504 as quickly as possible may be provided, for example by reducing the quantity or nature of absorbent material near the sensor, adding moisture-conducting material, and so on.

Various additional diaper and garment designs may be provided, including:
A disposable diaper, liner, or garment to which the diaper sensing unit 500 may attach, having printed conductive tracings on the inner (non-skin) surface of the liner that touches the child's skin. A variation includes a moisture-permeable sleeve adjacent to the child's skin into which a sensing strip or flexible detection patch/card can be inserted. The garment may also include a sleeve or detection element just inside the external layer of the diaper, to detect when the diaper is full.
A diaper system suitable for both daytime use, where the diaper or liner is changed after each elimination, as well as overnight, travel, and other situations in which frequent, immediate changes are impractical. In this embodiment, the diaper includes an outer cover into which a disposable thin absorbent liner with detection aspects is inserted, snapped, or otherwise attached. This outer cover may be washable cloth or a wipeable/reusable disposable material that lasts roughly one day. The inner absorbent liner may be cloth or a disposable/compostable/flushable absorbent material, and may be produced with various absorbent properties (such as a thin liner for training and a more absorbent liner for overnight, car trips, etc.).
One embodiment includes reusable/washable diapers and/or training pants that use similar design concepts as those discussed above, but with more durable detection elements such as conductive thread, or a sandwich of conductive fabrics with an absorbent, insulating layer in the middle. Reusable garments may be “one-size” with snaps, adjustable waist-bands, and other size-adjusting elements to cover from birth-to-3 months through 9-15 months. The system anticipates that many caregivers will be “training” part-time, and includes options for more-absorbent layers when rapid and/or frequent changes are not possible or desired

Early toilet training benefits from the ability for caregivers to both frequently and rapidly place the child in an elimination-ready position over a toilet or other waste receptacle. This process must be both quick and convenient, as must the process of changing soiled diapers or diaper liners/inserts. Therefore, diapers/garments with the following features provide these benefits.

One diaper embodiment comprises a one-piece (integral outer and inner layers) or two-piece (diaper cover with removable absorbent insert or liner) diaper with some combination of the following features:

A “persistent” elastic or other waistband that fastens or is pulled around the child's waist. By “persistent”, the waistband remains around the child's waist when the child is placed on the toilet or when the insert/liner is changed. A central portion of the diaper/cover is positioned to “catch” elimination products and attaches to a waistband of the diaper via hook & loop tabs or other fastener(s). The central portion can be flipped down to hang behind the child, flip up behind the child (via memory wire, elastic, or other shaping material), or be temporarily fastened to the back side of the waistband (via hook & loop tabs, magnets, or other fastener(s)) during elimination or liner/insert changes. This enables the caregiver to quickly move the central portion away from the child's crotch to facilitate elimination without requiring that the diaper be fully removed and later replaced. This also facilitates rapid, convenient changing of the diaper liner or insert, again without needing to fully remove the diaper from the child. In certain embodiments, the waistband connections and fastening of the flap happens behind the child, to reduce diaper opening by the child.

A two-piece embodiment allows a caregiver to replace a cloth or disposable insert without changing the diaper-cover every time, unless the diaper-cover is soiled (in which case it might be wiped and reused, washed, or disposed of). The insert can be disposed of into a diaper pail, normal trash, or the toilet, depending on the material. Disconnecting/ejecting the insert can happen as the child is being rapidly brought to the toilet.

An additional embodiment includes an integrated leg covering with a removable/swappable covering for the genital and buttocks area that contains misses, detects elimination, and/or allows more privacy than conventional “split-pants” with genital/buttock openings. Such an embodiment may utilize a flap attachment that attaches to a pant waistband at the front and back, allows for attachment of a diaper sensing unit 500, flips and/or attaches forwards or backwards for rapid removal, as well as swapping the flap attachment after a miss without needing to change pants.

Another diaper embodiment uses a persistent waistband to which is fastened a replaceable flap attachment. This is similar to the previous embodiment, but suitable for warmer environments, as the entire liner/cover may be removed from the waistband instead of being only moved out of the way.

Other garments for children that are actively training or “graduated” from the system are also provided, such as absorbent infant training underwear designed to briefly contain one “miss”. These may incorporate detection aspects as described above and may be a constructed from a washable/reusable material, with a thin absorbent inner layer and more liquid impermeable outer layer. This may be a disposable undergarment, but much less bulky than current diaper designs. This may also be a hybrid garment, with a reusable/washable outer layer and a disposable absorbent inner liner which is replaceable.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

1. A system and method formed according to the embodiments described herein.
